(19) United States
(12) Patent Application Publication
(10) Pub. No.: US 2021/0062764 A1
(43) Pub. Date: Mar. 4, 2021

(54) EFFECTOR HEALTH MONITOR SYSTEM AND METHODS FOR SAME

(71) Applicant: Raytheon Company, Waltham, MA (US)

(72) Inventors: Louis J. Gullo, Marana, AZ (US); Mark T. Langhenry, Tucson, AZ (US); Thomas R. Berger, Tucson, AZ (US)

(21) Appl. No.: 16/545,474

(22) Filed: Aug. 20, 2019

(51) Int. Cl. F02K 9/96; F02K 9/32

(52) U.S. Cl. CPC F02K 9/96; F02K 9/32

(57) ABSTRACT

An effector health monitor system is configured for coupling with an energetic component. The effector health monitor system includes a characteristic sensor suite including at least first and second characteristic sensors. The first characteristic sensor is proximate to the energetic component and configured to measure a failure characteristic of the energetic component. The second characteristic sensor is configured to measure at least one environmental characteristic proximate to the energetic component. A communication hub is coupled with the first and second characteristic sensors, and is configured to communicate the measured failure and environmental characteristics outside of an effector body. A failure identification module compares the measured failure characteristic with a failure threshold and identifies a failure event. A failure model generation module logs the at least one measured environmental characteristic preceding the identified failure event with the identified failure event and generates a failure model including updating the failure model.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raytheon Company of Waltham, Massachusetts. All Rights Reserved.

### TECHNICAL FIELD

This document pertains generally, but not by way of limitation, to monitoring and analysis of effector characteristics, environmental characteristics with regard to effector health.

### BACKGROUND

Effectors include one or more of rockets, missiles or the like configured to carry payloads. Payloads include, but are not limited to, warheads, satellites, instruments, combinations of these features or the like. The effector includes an energetic device, such as a rocket motor (e.g., solid or liquid propellant), a warhead, or other explosive or insensitive munition. Effectors including these components are shipped throughout the world on board air, land and sea transportation. Effectors are stored on warships, at armories, or munition warehouses for future use, and then deployed to the field with military or non-military units, launch vehicles or devices, aircraft, warships or like. In some examples, the effectors are stored for periods of months, years or longer with differing conditions including pressures, temperatures, vibrations or humidities. Transportation or installation of effectors (e.g., to aircraft hard points, armament housings or other weapon systems) includes manipulation, lifts, rotation or the like that impart one or more forces including mechanical shock, torques or vibration to the effector. One or more of storage including storage conditions and time of storage, transportation or installation may cause defects or decrease the usable life of the effector.

In some examples destructive testing of effectors is conducted to assess one or more characteristics of an effector model (e.g., from a specified manufacturing lot). These destructive tests include sectioning and inspection of rocket motor propellant (e.g., solid propellant) or a warhead for cracks, gaps or the like that may affect the specified operation of the rocket motor or warhead. Mechanical, physical, and chemical properties testing are performed to assess material property degradation and fatigue. In other examples, destructive testing includes ignition and observation of the operating rocket motor including measurement of thrust, pressure, mass flow rate, length of operation or the like. Alternatively, destructive testing of a warhead includes initiation and measurement (velocity and spray pattern) of the resulting detonation of the warhead. The observations of a subset of effectors destructively tested are used to determine a Remaining Useful Life (RUL) of the remaining effectors of the corresponding manufacturing lot. The RUL is the number of remaining years to predetermined age of the product or an expiration date or End of Life (EOL) for the effectors of the manufacturing lot. The remaining unused effectors in a field or fleet storage facility from a particular manufacturing lot (e.g., 50, 60, 70, 80, 90, 95 percent or more of the effectors) are decommissioned upon the examined effector reaching its EOL. The full interval of time, from manufacture date to expiration date, is known as the Service Life (SL) of the manufacturing lot.

In other examples, effectors are tested with nondestructive testing techniques including ultrasound examination, x-ray examination or the like. For instance, the effector rocket motor, warhead or the like is accessed with opening of an aft portion of the effector with removal of a weather seal, and examined with a borescope, or examined with ultrasound or X-ray systems. In a similar manner to destructive testing, the results of the nondestructive testing are used to determine a RUL, and other effectors of the corresponding manufacturing lot are evaluated based on the RUL of the examined effector. After reaching the RUL, the effectors of the manufacturing lot are decommissioned.

### OVERVIEW

The present inventors have recognized that a problem to be solved involves identifying a more accurate RUL, EOL or estimated service life (ESL) for effectors non-destructively based on actual environmental and failure indicating measurements from in-service effectors (e.g., all effectors, a large majority, large minority or the like). The methods described herein contrast to an estimated Remaining Useful Life (RUL) metric, based on the examination of a sample of effectors and then imputing the determined RUL to all effectors of the corresponding manufacturing lot. For example, in previous methods one or more of destructive or nondestructive testing is conducted with a sample of effectors from a manufacturing lot (e.g., 5 percent or less, 1 percent or less or the like). In various examples destructive testing destroys one or more effectors, a significant expense and potential hazard, while nondestructive testing is expensive and labor intensive. The RUL for the lot (and not just the effector under examination) is determined from this limited testing and imputed to all of the effectors for that lot. For instance, if the examined effectors show cracking of a propellant grain, delamination from the propellant housing or the like the EOL for the lot is assessed as having been reached and the remaining effectors are removed from service.

Upon reaching the EOL for a sample effector under examination all remaining effectors from the lot (e.g., approximately the same age) are decommissioned and removed from service. In some examples, ‘good’ effectors that are in fact operational are removed from service based on the determined EOL from the sample effector or effectors. In other examples, ‘bad’ effectors that should be removed from service instead remain in service because the EOL for the sample effector is not yet reached based on the examination of the sample effector or effectors. For example, if the tested sample effectors experience a service life different from other effectors of the manufacturing lot the determined RUL will likely vary toward early decommissioning of ‘good’ effectors or late decommissioning of ‘bad’ effectors that should have been retired earlier.

The present subject matter provides a solution to this problem with an effector health monitor system configured to monitor one or more environmental characteristics of each effector and identify a failure event for the effector based on the one or more monitored environmental characteristics. Identification of a failure event includes a prediction of a forthcoming failure event based on analysis of the environmental characteristics with one or more failure or aging models generated from prior wearout or failure events (collectively failure events) for other effectors of the same type (e.g., manufacturing lots, models or the like). These failure events with their corresponding characteristics are collected with data stored as historical records.

In one example, the effector health monitor system includes a characteristic sensor suite having at least a first characteristic sensor configured to measure a failure characteristic of an energetic component, such as stress or strain degradation, thermal age, changes in chemical composition or the like. In some examples, these first characteristic sensors are referred to as Category 2 sensors. The characteristic sensor suite further includes one or more second characteristic sensors (sometimes referred to as Category 1 sensors) configured to measure at least one environmental characteristic proximate to the energetic component (e.g., within or in proximity to the effector, such as within a warehouse, storage room, onboard a vehicle or the like). A non-exclusive list of Category 1 and Category 2 sensors are described in the following Table. The Category 1 and 2 sensors include, but are not limited to:

| | Category 1 | Category 2 |
|---|---|---|
| Type | Environmental Conditions | Critical Parameters (Failure) |
| Attributes | Monitor attributes of | Monitor critical performance |
| | environmental conditions | parameters (e.g., electrical, |
| | that stress and accelerate | mechanical, chemical and mass |
| | degradation aging | properties) |
| | mechanisms | |
| Charac- | Remotely measure | Remotely measure, for |
| teristic | temperature, humidity, | example, power, voltage, |
| Measured | vibration, shock and | current, charge, stress/strain |
| | pressure | (pressure), conductivity, |
| | | timing and outgassing |
| Approach | Accommodate future sensor | Track actual “in spec” and |
| | design with lower error | “out of spec” conditions, |
| | rates (e.g., higher | along with false alarm rates |
| | accuracy and reliability) | |

In another example, the monitor system includes a communication hub that interfaces with the characteristic sensor suite (including one or more Category 1 and 2 sensors) and is configured to receive and communicate each of the failure characteristic measurements (including plural characteristics) and at least one environmental characteristic measurements (also including plural characteristics). In various examples, the environmental characteristic sensors are located inside or outside of an effector body (e.g., outside of a missile body, storage housing or the like). A failure identification module compares the measured failure characteristic with a failure threshold including, but not limited to, a specified thermal age, specified strain or stress, electrical characteristics (power, voltage, current, charge or the like), rates of change of the same or the like, and identifies (e.g., predicts or detects) a failure event based on the comparison. In some examples, the failure identification module is embedded with a Physics of Failure (PoF) model or algorithm, and the PoF model calculates time-stress acceleration factors based on the physics-based data it is derived from. This data is accumulated from various environmental stress parameters (e.g., measured environmental characteristics) and design parameters to determine when a failure event occurs, for instance within a certain confidence boundary. Upon identification of the failure event the monitor system logs the measured environmental characteristic (an example failure condition) preceding the failure event. Optionally, a plurality of measured environmental characteristics preceding the failure event are associated as an example failure condition. A failure model generation module (FMGM) logs one or more failure conditions each including one or more environmental characteristics preceding the identified failure event.

The FMGM generates one or more failure models (e.g., PoF models) based on the logged failure conditions, for instance mathematically, statistically or empirically generated failure models (including modification of a base model, development of a model from measurements in other similar effectors or the like). In one example, the logged failure conditions each correspond to a failure model including a plurality of component failure models. An effector that includes an example effector health monitor system with a characteristic sensor suite including one or more environmental sensors that perform ongoing measurements such as temperature, pressure, humidity, vibration, or shock, rates of change of the same or the like compares the measurements with the failure models (e.g., logged failure conditions). A failure prediction is returned based on the correspondence of the ongoing measurements of the environmental characteristics to one or more of the failure models. For instance, closer correspondence indicates one or more of a higher confidence of the predicted failure or proximity in time of the predicted failure.

Optionally, the effector includes failure characteristic measuring sensors configured to continue detection of failure events and log the corresponding failure conditions to provide with the FMGM additional failure models, updating of existing failure models or the like for higher resolution health monitoring. In other examples, the FMGM determines if the current failure model (including plural models) embedded in the failure identification module is accurate. If the failure model is inaccurate (e.g., a prediction of failure varies from a later identified failure event) the model is optionally updated based on the time difference between the actual Time-To-Failure (TTF) from the logged environment measurements to the failure event and the predicted RUL (e.g., the predicted time period to the predicted failure from the logged environmental measurements).

In other examples, the logged failure conditions are synthesized to generate a synthesized failure model, for instance an empirically generated synthesized failure model. For example, one or more of curve fitting, linear regression or similar techniques are used with multiple explanatory variables (e.g., environmental characteristics and the corresponding logged failure conditions) to generate a synthesized failure model (probability density function, cumulative distribution function or the like) for predicting failure of the monitored energetic component. In one example, multiple logged failure conditions and the environmental characteristic values associated with each failure condition, such as values for humidity, pressure, temperature, shock, vibration or the like, are evaluated to generate one or more failure models configured to predict the failure of an effector based on measured environmental characteristics.

The inclusion of one or more failure models with the effector health monitor system allows for the discrete evaluation of each effector of the same type (e.g., across a manufacturing lot, model or the like) and prediction of failure for each effector based on the unique environmental conditions each effector experiences. Accordingly, the failure prediction for effectors stored primarily in a warehouse in desert conditions relative to effectors transported at altitude, stored on vessels or combinations of the same will vary based on the unique measured environmental characteristics for each effector and the application of those measurements to the one or more failure models. Further, the failure prediction for an effector is unique to that effector because it is based on the measured environmental experience for the specified effector. Accordingly, the removal from service of a ‘bad’ effector that is predicted to fail in the near future (weeks, months, a year or the like) is not imputed to the remainder of the lot including ‘good’ serviceable effectors. Instead, the remaining effectors are evaluated based on the failure models (including updated failure models) and their own unique environmental experience. Similarly, the retention in service of an effector as ‘good’, and thereby not predicted to fail in the near further, is not imputed to the remainder of the lot. Instead, the remaining effectors are evaluated based on their experience and removed from service if their unique environmental experience indicates they are predicted to fail.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a cross sectional view of one example of an effector including one or more degradable components.

FIG. 2 is a schematic view of a manufacturing lot of effectors including a subset of evaluated effectors from the manufacturing lot.

FIG. 3A is a cross sectional view of an effector including one example of an effector health monitoring system.

FIG. 3B is a schematic view of the effector health monitoring system of FIG. 3A.

FIG. 4 is a perspective view of one example of a single or multiple characteristic sensor.

FIG. 5 is a schematic view of one example of a thermal age sensor.

FIG. 6 is a cross sectional view of a rocket nozzle and another example of a single or multiple characteristic sensor within the rocket nozzle.

FIG. 7A is a cross sectional view of an effector including another example of an effector health monitoring system.

FIG. 7B is a schematic view of the effector health monitoring system of FIG. 7A.

FIG. 8 is an exploded view of an effector storage housing including another example of an effector health monitoring system.

FIG. 9 are example probability distribution functions for a plurality of failure modes.

FIG. 10 are probability distribution functions for an example failure mode based on varied input stress.

FIG. 11 are example failure models for the probability distribution functions of FIG. 10 including estimated service lives (ESL) according to a specified failure tolerance.

FIG. 12 are example plots of a plurality of failure events and preceding environmental characteristic measurements for each of the failure events.

FIG. 13 is one example of refined probability distribution functions for the failure mode of FIG. 10 based on an input stress and supplemental identified failure events.

FIG. 14 is one example of refined failure models for the probability distribution functions of FIG. 13 including estimate service lives (ESL) according to the specified failure tolerance of FIG. 11.

### DETAILED DESCRIPTION

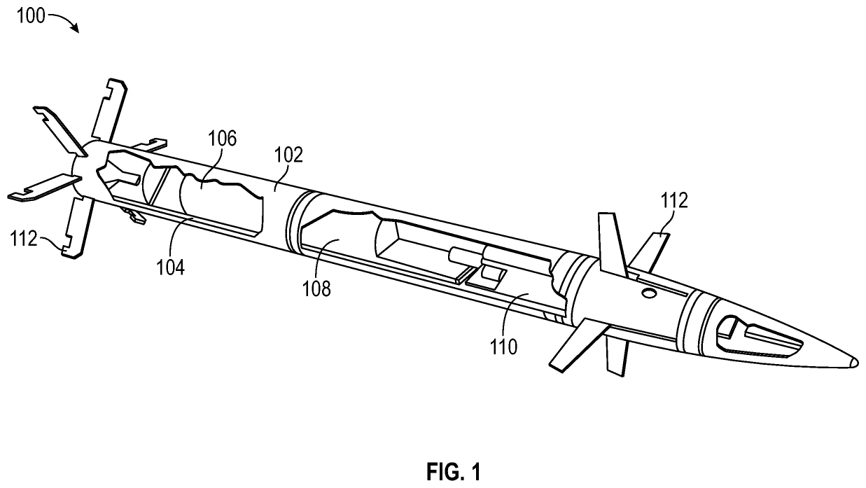

FIG. 1 is a perspective view of one example of an effector 100. In this example, the effector 100 includes, but is not limited to, a missile, rocket, munition, energetic component or the like. In various examples, the effector 100 includes one or more of tactical, medium range, short range missiles or the like. In another example, the effector 100 includes, but is not limited to, a transatmospheric missile or the like. As shown the effector 100 includes an effector body 102 having one or more energetic components. A rocket motor 104 is one example of an energetic component. In other examples, the effector 100 includes one or more energetic components including, but not limited to, warheads, explosives, insensitive munitions, squib charges or the like. As shown in FIG. 1, the rocket motor 104 is optionally a solid rocket motor and includes a propellant grain 106 positioned within the rocket motor 104. For example, the propellant grain 106 is a solid rocket propellant housed within the rocket motor 104, such as along or within a liner of the rocket motor 104.

Referring again to FIG. 1, the effector 100 includes one or more sets of control surfaces 112 provided at one or more locations along the effector body 102. In this example, the control surfaces 112 are provided at the base of the effector body 102 proximate to the rocket motor 104. In another example, the effector 100 includes one or more control surfaces 112 proximate to a nose cone or leading end of the effector body 102.

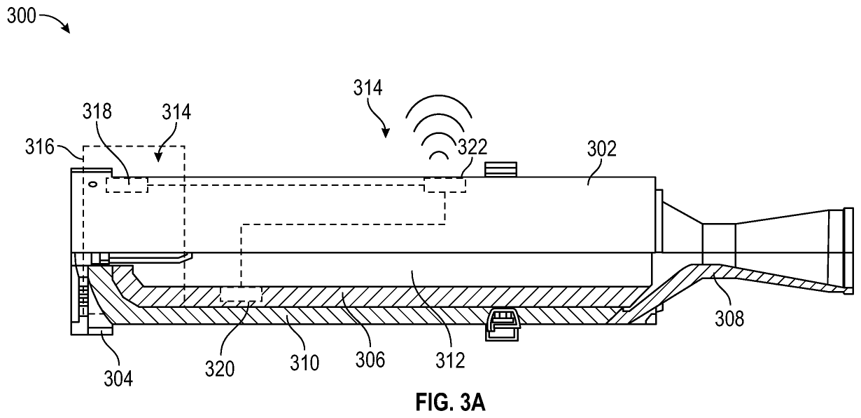

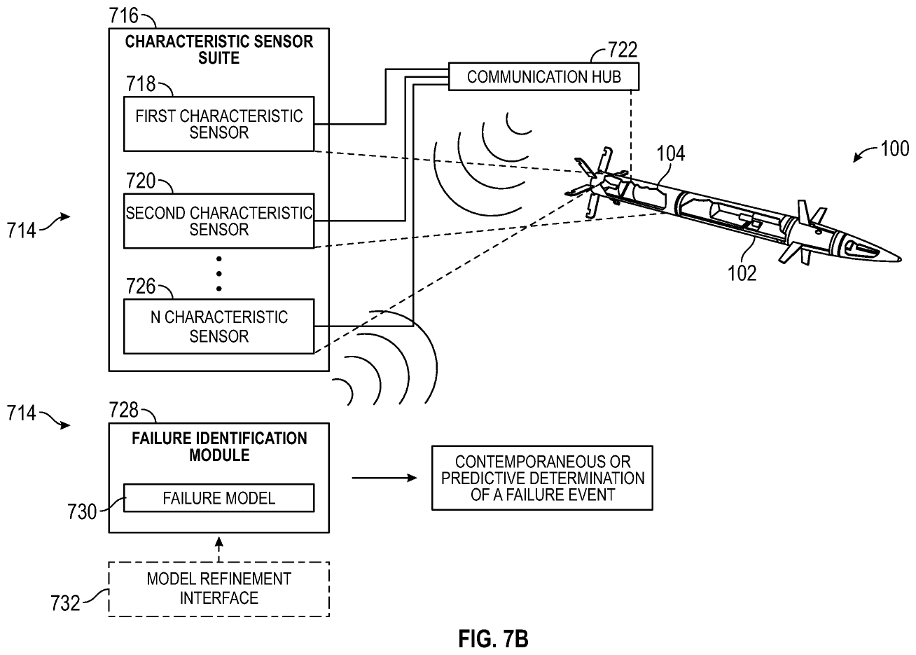

In this example, the effector 100 further includes one or more control systems, electronics, telemetry, communication systems or the like. For instance, the control systems 110 are, in one example, positioned toward the nose cone of the effector body 102 and distal relative to the rocket motor 104. As will be described herein and, in various examples, one of the systems for the effector 100 includes an effector health monitoring system. Example effector health monitor systems 314, 714 are shown in FIGS. 3A, 7A and further described herein. The effector health monitor system examples described herein measure one or more characteristics proximate to or associated with an energetic component. For instance, in the example shown in FIG. 1, the effector health monitor system is associated with the rocket motor 104, including the propellant grain 106. The effector health monitoring system measures one or more characteristics proximate to the rocket motor including, but not limited to, one or more environmental characteristics such as temperature, humidity, pressure, shock or the like (including changes and rates of change of the same) and optionally one or more failure characteristics including, but not limited to, strain, stress, pressure or the like (including changes and rates of change of the same), associated with the propellant grain 106 or other energetic component. In another example, one or more other failure characteristics are measured including, but not limited to, chemical composition (e.g., by way of outgassing measurements, electrical measurements or the like) electrical characteristics including, but not limited to, power, voltage, current, charge or the like measured through the propellant grain 106 or measured with systems associated with the grain 106 or rocket motor 104.

The failure characteristics are, in some examples, used to identify (e.g., detect or determine) one or more failure events associated with the energetic component such as the rocket motor 104, the propellant grain 106 or other systems associated with energetic components. As will be described herein, the measured environmental characteristics are associated with detected failure events, and are used to generate one or more failure models with a failure model generation module. In other examples, the generation of the failure models includes the modification of an initial failure model generated based on previous identified failure events, effector maintenance experience (e.g., of the same manufacturing lot), historical failure events (e.g., for a type of motor, propellant, munition, charge or the like). The initial failure model is revised according to one or more identified failure events and associated environmental measurements taken with the effector health monitoring systems prior to the failure events.

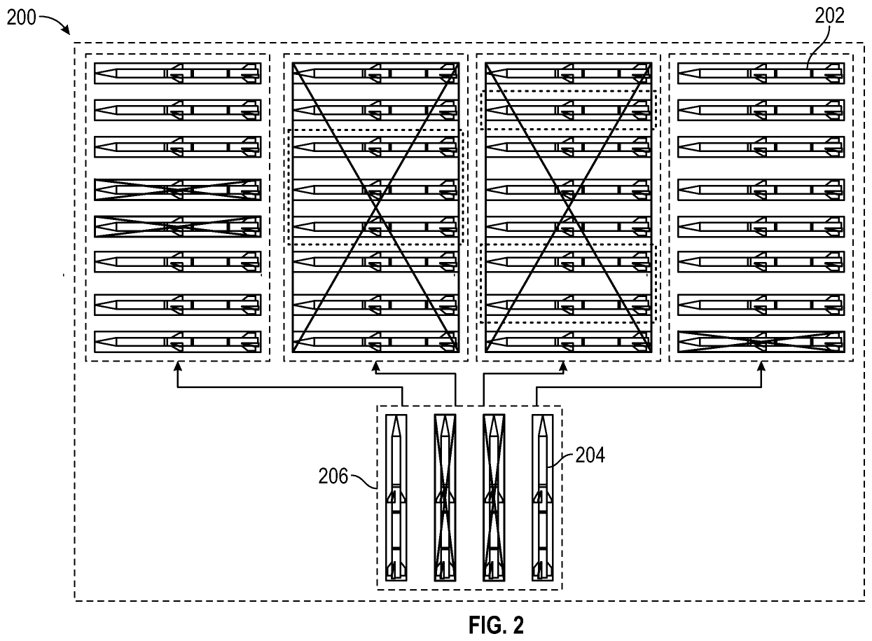

FIG. 2 is a schematic example of a series of effectors 202. In this example, the effectors 202 are from a common manufacturing lot 200, including a plurality of the same effectors 202. As described herein, the effectors 202 shown in FIG. 2 are, in this example, examined by way of selection of one or more of the effectors from each of one or more corresponding sublots of the manufacturing lot 200 to ascertain the condition of the effector including the condition of the energetic component such as the propellant grain of each of the selected effectors. As described further herein, the examination of the evaluated effectors 204 is imputed to the corresponding sublot of the manufacturing lot 200 the effector is drawn from.

As shown in FIG. 2, the effectors 202 are divided into four subgroups or sublots relative to the overall manufacturing lot 200. The sublots of the effectors 202 are divided by dash boxes. As further shown in FIG. 2, one or more evaluated effectors 204 are pulled from each of the sublots. The evaluated effectors 204 are a sample subset 206 and are, in various examples, destructively or nondestructively tested to identify failure events. In a destructive testing example, the evaluated effectors 204 are disassembled and the propellant grain removed therefrom. The propellant grain is, in at least some examples of destructive testing, sectioned and examined to determine if one or more failure events has occurred with the propellant grain including, but not limited to, liner separation relative to the propellant grain, fracture of the propellant grain or the like. Based on the evaluation of the evaluated effector 204, the corresponding sublot associated with each evaluated effector 204 remains in service or is pulled from service.

For instance, with the first (left most) evaluated effector 204 pulled from the first sublot of the manufacturing lot 200 the effector receives a passing grade when examined with destructive or nondestructive testing. Based on this evaluation, the entirety of the sublot of the manufacturing lot 200 is deemed serviceable and accordingly continues in service. However, as shown in FIG. 2, the sublot associated with the evaluated effector 204 has at least two effectors 202 (crossed out) that include unidentified failure events but are not decommissioned .

Referring again to FIG. 2, the next evaluated effector 204 (second from the left), when pulled from service and examined with destructive or nondestructive testing, is identified as nonserviceable. For example, the evaluated effector includes one or more identified failure events. Accordingly, the evaluated effector 204 is marked out in FIG. 2 and the entirety of the corresponding sublot of effectors 202 receives a like indication (e.g., the failure event is imputed to the effectors). As shown in FIG. 2, the second sublot from the left is entirely crossed out and accordingly decommissioned. However, at least three of the effectors 202 (in a dashed box with a different weight or pattern) of this sublot are in fact serviceable and do not include a failure event of the type detected with the associated evaluated effector 204. Accordingly, by decommissioning the entirety of the sublot, one or more effectors 202 that are otherwise fully serviceable are removed from service prior to a failure event. As will be described herein, the effectors 202 shown, for instance, in the dashed box of the sublot experience different environmental conditions based on storage conditions, transport conditions, use or the like and accordingly have a different and unique environmental experiences. In this scenario the failure event present in the evaluated effector 204 that precipitated the decommissioning of the sublot are, in some examples, not present in all of the effectors of the sublot.

Referring again to FIG. 2, the third evaluated effector 204 (second from the right) of sample subset 206 is also deemed unserviceable when exampled and accordingly the effectors 202 associated with its sublot are also deemed unserviceable. In a similar manner to the previously described sublot, one or more of the effectors 202 in the sublot are in fact serviceable (as shown with dashed line boxes around the serviceable effectors). The serviceable effectors 202, as well as the remainder of the effectors 202 in the sublot, are pulled according to the imputed service determination based on examination of the evaluated effector 204.

In contrast, the evaluated effector 204 shown at the rightmost of the evaluated effectors of the sample subset 206, receives a passing grade when examined destructively or nondestructively. Accordingly, the effectors 202 associated with the sublot of the manufacturing lot 200 are also deemed serviceable. However, as shown in FIG. 2, for instance, with the crossed-out box on the last effector 202 of the sublot at least one of the effectors 202 is in fact unserviceable. Accordingly, the passing evaluation of the evaluated effector 204 of the sample subset 206 is inaccurately imputed to at least one failing effector 202 of the corresponding sublot of the manufacturing lot 200.

Accordingly, as shown in FIG. 2, one or more of good (passing) or bad (failing) evaluations of the evaluated effectors 204 in the sample subset 206 are imputed to a corresponding sublot of effectors 202. By imputing the service determinations made with each of the evaluated effectors 204 to their respective sublots, one or more errant determinations are made relative to the serviceability of one or more of the effectors 202. These errors include, but are not limited to, removing one or more serviceable effectors 202 from a sublot otherwise designated as unserviceable, or retaining one or more unserviceable effectors 202 in a lot that is otherwise determined to be serviceable according to the evaluation of the evaluated effector 204. Accordingly, even where environmental conditions experienced by each of the effectors 202 vary the evaluation of the effectors 204 of the sample subset 206 , is still imputed to the entirety of the effectors 202 associated with that manufacturing sublot or lot 200. Stated another way, the service life determination of each of the effectors 202 of the entire manufacturing lot 200 is based on a service life determination of a limited number evaluated effectors 204. This method of service life determination limits the accuracy of service life determinations in contrast to the methods described herein that generate failure models, and apply actual experienced environmental conditions to the failure models to identify failure events for the associated effector.

FIG. 3A shows another example of an effector 300. In this example, a portion of an overall effector 300 is shown. The effector 300 includes a rocket motor 304 housed within the effector body 302. As further shown, the rocket motor 304 includes a propellant grain 306 within a liner 310. The repellant grain 306, in this example, includes a center bore 312 extending along the propellant grain 306 toward a nozzle 308. The propellant grain 306 shown in FIG. 3A is a solid propellant grain. In the solid propellant grain 306 combustion is initiated along the center bore 312 and consumes the propellant grain 306 from the interior to the exterior. In various examples, combustion of the propellant grain 306 is begun and maintain within the center bore 312 (as opposed to the perimeter of the grain) to control the performance of the propellant grain 306 and the rocket motor 304. Combustion along one or more other surfaces, for instance, along cracks, at points of delamination between the grain the liner 310 or the like affects the performance of the propellant grain 306 and, in some examples, causes failure of the effector 300, poor performance of the effector 300 or the like.

Referring again to FIG. 3A, one example of an effector health monitor system 314 is schematically shown. In this example, the effector health monitor system includes a characteristic sensor suite 316 including one or more characteristic sensors configured to measure environmental characteristics in and around the energetic component (here the rocket motor 304) as well as one or more failure conditions or failure characteristics associated with the energetic component. In the example shown in FIG. 3A, the characteristic sensor suite 316 includes a first characteristic sensor 318 coupled proximate to the rocket motor 304 and exposed to an environment within or around the rocket motor 304. The first characteristic sensor 318 includes, but not limited to, an environmental sensor configured to measure one or more of pressure, temperature, humidity, vibration, shock, including changes or rates of change of the same or the like associated with the rocket motor 304 and the effector 300.

As further shown in FIG. 3A, the characteristic sensor suite 316 includes another characteristic sensor, in this example, a second characteristic sensor 320. The second characteristic sensor 320 shown in FIG. 3A is coupled with the rocket motor 304 at a location proximate to the propellant grain 306 (e.g., along, within, embedded or the like) to measure one or more failure characteristics of the propellant grain 306. As described herein, the second characteristic sensor 320 is, in one example, used with a failure identification module to identify one or more failure events in the propellant grain 306 in a nondestructive manner. For example, the second characteristic sensor 320 includes one or more sensors configured to measure stress, strain, stress/strain, temperature, electrical properties (including power, voltage, current, charge or the like), chemical composition, polymer aging or the like including change of the same or rates of change. In another example, the second characteristic sensor 320 is provided at a location spaced from the propellant grain 306, for instance outside of a weather seal (including along an exterior surface of the weather seal), and thereby configured to measure failure characteristics local to the propellant grain 306 and effector. In various examples, a plurality of second characteristic sensors 320 are included with the system to provide multiple potential measurements of failure characteristics. The second characteristic sensors 320 described herein include, but not are not limited to, sensors configured to sense failure events (e.g., failure characteristics indicative of a failure event) including, but not limited, polymer aging sensors (thermal aging sensors configured to apply a thermal pressure algorithm), fiber Bragg grating sensors (configured to measure mechanical and chemical changes through light and doppler changes), accelerometers to measure strain and shear (correlates to pressure and stress), pressure sensors (corresponding to stress/strain in the propellant grain) or the like.

The failure identification modules described herein identify failure events through comparison of the measured failure characteristics with one or more failure models including, but not limited to, equation based models (e.g., Arrhenius functions, empirically determined models based on historical data or the like), threshold values or the like. As described herein, the characteristics measured with the other sensors of the characteristic sensor suite 316, for instance, one or more environmental characteristics measured by the first characteristic sensor 318 are in various examples associated with identified failure events and used, in some examples, for generation of a failure model, including development of an initial failure model or refinement of an existing failure model or the like.

Referring again to FIG. 3A, in this example the effector health monitor system 314 further includes a communication hub 322 in communication with each of the sensors 318, 320 of the characteristic sensor suite 316. In an example, the communication hub 322 wirelessly communicates with one or more assessment tools including, but not limited to, a separate device such as a processor, computer, smart phone, tablet computer, lap top, service module, mobile phone or the like having the failure identification module (and optional failure model generation module) therein. In another example, the communication hub 322 includes one or more processors, memory or the like to accordingly identify failure events, log environmental characteristics and generate (or refine) the failure model. In the example shown in FIG. 3A, the communication hub 322 includes wired connections between each of the characteristic sensors 318, 320 and the communication hub 322. Optionally, a BUS or other network interface system is provided for intercommunication between the hub 322 and the sensors. The communication hub 322 is, in one example, provided along the effector body 302 and delivers one or more of the measurements from the characteristic sensors 318, 320 outside of the effector body 302, for instance, to a failure identification module. The communication format used with communication hub 322 includes, in various examples, one or more of infrared communication, RFID communication, wireless communication standards, including Bluetooth or the like. In other examples, the communication hub 322 includes a wired communication interface including one or more of a USB port, data jack or the like configured to interconnect the characteristic sensors 318, 320, onboard modules associated with the effector health monitor system 314 (e.g., failure identification module, failure generation module or the like) and one or more exterior or outboard components including, for instance, an assessment tool such as a smartphone, tablet computer, service module or the like.

FIG. 3B is a schematic diagram of the effector health monitor system 314. The effector health monitor system 314 is coupled with the effector 100 previously shown in FIG. 1 or the rocket motor 304 shown in FIG. 3A. The characteristic sensor suite 316 is shown in an exploded view relative to the effector 100 and includes the first and second characteristic sensors 318, 320. In the example shown in FIG. 3B, the first characteristic sensor 318 of the characteristic sensor suite includes one or more environmental sensors. The environmental sensors 320 shown in FIG. 3B are proximate to one or more components of the effector 100 and are configured to measure environmental characteristics in and around the effector 100 including the rocket motor and propellant grain. As previously described, the monitored environmental characteristics include, but are not limited to, temperature, humidity, environmental pressure, mechanical shock, vibration, changes of the same, rates of change or the like.

Additionally, the effector health monitor system 314 includes one or more failure sensors configured to measure one or more failure characteristics associated with an energetic component of the effector 100, such as the propellant grain, munition, charge, squib charge or the like. For instance, in the example shown in FIG. 3B, the failure sensor 320 (e.g., an example of the second characteristic sensors) is associated with the rocket motor 104. The second characteristic (failure characteristic in this example) sensor 320 is associated with an energetic component such as the rocket motor 304 having the propellant grain 306. In one example, the second characteristic sensor 320 is provided along or within the propellant grain, is coupled between the propellant grain 306 and the liner 310 or the like. The second characteristic sensor 320 in this example of the effector health monitor system 314 measures one or more failure characteristics including, but not limited to, stress, strain, pressure within or along the propellant grain, temperature of the propellant grain, polymer aging characteristics (e.g., thermal aging, thermal pressure or the like), chemical changes of the propellant grain including changes in composition of the grain or the outgassing. In other examples, the failure sensor 320 measures one or more other failure characteristics including, but not limited to, electrical properties (e.g., power, voltage, current, resistivity or the like) associated with the propellant or components associated with the propellant.

As further shown in FIG. 3B, the characteristic sensor suite 316 including the one or more sensors 318, 320 through the communication hub 322. As previously described, the communication hub 322 is a communication interface from the effector 100 to one or more exterior modules including, for instance, the failure identification module 324, one or more displays, other output devices or the like. The communication hub 322 facilitates communication of the characteristic measurements taken with the sensors 318, 320 that are otherwise difficult to broadcast from the effector 100 because of electromagnetic interference from the effector body 102. For example, the communication hub 322 includes a transceiver (including a transmitter, transmitter and receiver or the like) to communicate with one or more components of the effector health monitor system 314. In one example, the communication hub communicates by way of Bluetooth, infrared communication, radio connection or the like to one or more components of the effector health monitor system 314.

Examples of a failure identification module 324 and failure model generation module 330 are shown in FIG. 3B. The failure identification module 324 interprets one or more measured characteristics from the characteristic sensor suite 316 to identify a failure event with the effector 100. For instance, in one example, the failure identification module 324 includes a series of thresholds (e.g., one or more of pressure, temperature, stress or strain, polymer aging thresholds, changes of the same, rates of change of the same or the like) to identify failure events. The failure identification module 324 compares measurements of the failure characteristics conducted with the failure sensor 320 to identify a failure event occurrence. For example, measurements taken with the failure sensor 320 are transmitted through the communication hub 322 to the failure identification module 324. The failure identification module 324 compares the measured values against corresponding thresholds (e.g., stress, strain, pressure, temperature, polymer aging). A failure event is identified if one or more of these characteristic measurements satisfies the appropriate threshold (exceeds or falls beneath the threshold as appropriate).As further shown in FIG. 3B, the effector health monitor system 314 optionally includes a failure model generation module 330. In the example shown, the failure model generation module 330 includes an association module 332 and a relationship module 334. The association module 332 associates the detected failure event identified by the failure identification module 324 with the corresponding (preceding) measured environmental characteristics. For instance, the measurements of one or more of temperature, humidity, pressure, shock or the like measured by the environmental sensors, such as the first characteristic sensor 318 shown in FIG. 3B is associated with the identified failure event. In the diagram shown in FIG. 3B, the failure event 332 is indicated with a vertical line and arrow extending backward along a time axis. The preceding measured values for each of temperature, humidity, pressure and mechanical shock are shown schematically.

The associated failure event 332 and environmental characteristic measurements are forwarded to the relationship module 334. The relationship module 334 generates one or more failure models based on the associated environmental characteristics relative to the identified failure event. For instance, one or more of pressure, humidity, temperature or mechanical shock measurement peaks, troughs, trends or the like are used by the relationship module 334 to generate a failure model. In some examples, a failure model, such as an Arrhenius Equation or other predictive model is populated with one or more values pulled from the associated environmental characteristic measurements or values determined from the measurements or the like. The association module 332 and the relationship module 334 modify, update or the like (e.g., revise) the one or more failure models to accordingly account for recently identified failure events and associated environmental characteristic measurements whether with the instant effector 100 shown in FIG. 3B or one or more effectors 100 from the same or similar manufacturing lot. Optionally, updated failure models based on measurements and identified failure events in other effectors 100 are provided to the failure identification module 324 to further refine identification of failure events. In still other examples, the failure model generation module 330 develops models and refines the models in an ongoing manner. For instance, the module 330 generates failure models based on the observed (measured) environmental characteristics and develops empirical functions reflecting a likelihood that a failure event follows one or more observed environmental characteristics (including measured values, change in values and rates of change, trends, peaks, troughs or the like).

Accordingly, the effector health monitor system 314, in one example, is configured to identify failure events, and generate failure models (develop or refine) to more accurately identify failure events across a family of effectors, such as a shared manufacturing lot. In another example, generation of failure models, refinement of models or the like are optionally used to predict remaining useful life (RUL), an estimated service life (ESL), or an estimated end of a life (EOL) for the effector 100 (e.g., one or more energetic components associated with the effector). The onboard failure models for the effector health monitor system 314 in combination with measured environmental characteristics for each effector 100 facilitate predictive identification of one or more forthcoming failure events to determine a remaining useful life based on the unique environmental conditions experienced by each effector. Stated another way, the effector health monitor system 314 provides a predictive diagnosis of the health of an associated effector based on the actual experience of the effector, and thereby minimizes broad imputation based decommissioning of effectors of a manufacturing lot based on an identified failure event of one or a subset of effectors.

In some examples, the failure models generated with the effector health system 314 provide an estimated remaining useful life (RUL) that facilitates the continued service of an effector 100 while at the same time identifying a time and likely failure mechanism for the effector 100 based on measured environmental characteristics unique to the instant effector. Accordingly, the effector 100 is readily left in service until the corresponding failure event is scheduled to occur or sometime therebefore, for instance, based on a safety factor of a year, two years or the like. Once the remaining useful life is attained and accordingly end of life has occurred for the effector 100, the effector 100 is decommissioned and pulled out of service.

Optionally, when decommissioned based on the predictive analysis (RUL) the effector 100 is destructively or nondestructively tested to accordingly determine if a failure event has in fact occurred. In one example, a failure event (positive result) or lack of an actual failure event (false positive results) as well as the associated environmental characteristics measured prior to the predicted or actual failure events are used by the failure model generation module 330 to further refine the failure model.

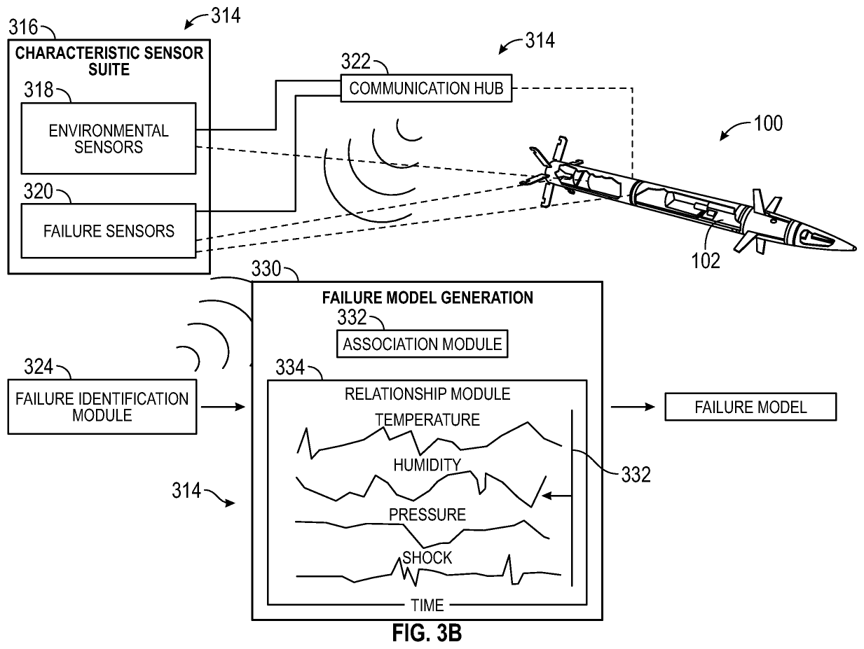

Referring now to FIG. 4, one example of a characteristic sensor 400 is shown. In this example, the characteristic sensor includes a stress/strain sensor or a combination stress/strain and temperature sensor. The characteristic sensor 400 includes a sensor substrate 404 as well as a stress/strain element 402 coupled along the sensor substrate 404. A sensor interface 406 is coupled with the stress/strain element 402 to interface the characteristic sensor 400 and one or more measurements of strain, stress, temperature or the like to another component of the effector health monitor system 314 such as the communication hub 322 previously shown and described in FIG. 3A.

Optionally, the characteristic sensor 400 is a dual bonded stress temperature (DBST) sensor configured to measure one or more of stress, strain and temperature. The DBST is, in one example, a DBST sold by Micron Instruments of Simi Valley, Calif. In an example, the temperature sensor component of the characteristic sensor 400 is used to automatically calibrate the stress/strain element 402 and accordingly account for temperature drift (e.g., thermomechanical drift) and corresponding changes in the materials of the stress/strain element 402 and the sensor substrate 404. In another example, the temperature sensor component of the characteristic sensor 400 is used as a temperature sensor or supplemental temperature sensor for the effector health monitor system 314. For example, the temperature sensor component is optionally a supplemental sensor to another temperature sensor provided with the effector health monitor system 314 as another characteristic sensor of the characteristic sensor suite 316 shown in FIG. 3A.

The sensor substrate 404, including the stress/strain element 402 thereon, is coupled between one or more components of the effector. With a dual bonded stress temperature sensor the sensor substrate 404 is in one configuration coupled along the liner 310 and the propellant grain 306 in liquid form is poured into the liner 310. As the propellant grain liquid sets, the sensor 400 is coupled along and affixes to both the liner 310 and the propellant grain 306 to measure stress/strain between the liner and grain. The characteristic sensor 400 is thereby able to measure one or more of stress or strain between the propellant grain 306 and the liner 310 by virtue of the dual bonding between the characteristic sensor 400 and each of the propellant grain 306 and the liner 310. With the characteristic sensor 400 coupled between the liner 310 and the propellant grain 306, the characteristic sensor 400 measures the differential stress or strain between the liner 310 and the propellant grain 306. In one example, for instance, with delamination, cracking or the like of the propellant grain 306 relative to the liner 310, one or more of stress or strain rises until the delamination event occurs at which time the measured stress or strain accordingly rapidly changes (decreases), for instance, relative to a stress/strain change threshold, previous measurement or the like. In one example, the failure identification module 324 of the effector health monitoring system 314 detects the change in stress, strain or the like of the characteristic sensor 400 and identifies the corresponding change in the stress or strain as indicative of a failure event in the propellant grain 306.

In another example, the characteristic sensor 400 is embedded in the propellant grain 306. For instance, the propellant grain 306 is poured around the characteristic sensor 400 and the stress/strain element 402 is measures stress/strain internal to the propellant grain 306. As one or more of the shape, temperature, composition or the like of the propellant grain 306 changes over time, the propellant grain 306 accordingly shrinks, expands or the like. Because the propellant grain 306 is adhered along the liner 310 corresponding changes in the propellant grain 306 generate stress and strain in the propellant grain 306 that is measured by the stress/strain element 402. In a similar manner to the dual bonded example previously described herein, the stress or strain is measured and monitored by the effector health monitor system 314 shown in FIG. 3A. The failure identification module 324 identifies a failure event based on comparison of the stress or strain measurements with one or more thresholds (e.g., one or more thresholds for stress/strain spikes, unpredicted rises, falls or the like).

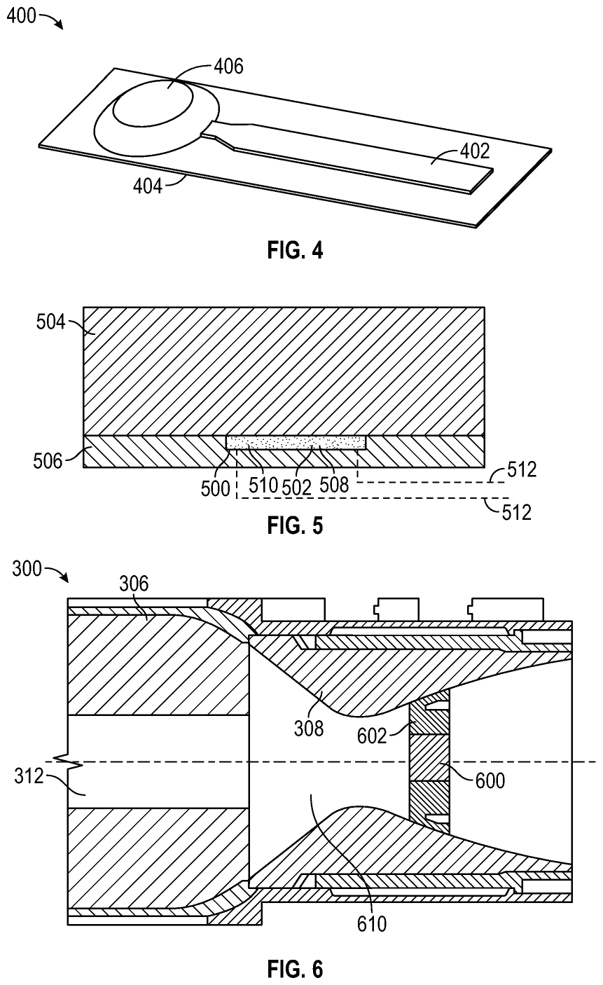

FIG. 5 shows another example of a characteristic sensor 500. In this example, the characteristic sensor 500 is configured to measure one or more chemical properties, for instance, thermal age of an energetic component. The characteristic sensor 500 is coupled along the energetic component 504, for instance, interposed between the liner 506 and the energetic component 504. The characteristic sensor 500 includes a sensor element 502 having conductive particulate 508 included in a polymer substrate 510. The polymer substrate 510 has a similar composition to the energetic component 504 and accordingly degrades in a similar fashion to the energetic component 504. As further shown in FIG. 5, contacts 512 are provided at locations along the polymer substrate 510.

In one example, the characteristic sensor 500 is a polymer aging sensor configured to measure an age of the energetic component 504 by measuring a corresponding aging of the polymer substrate 510. As previously described, the polymer substrate 510 has a related composition relative to the energetic component 504. Because of its related composition and proximity to the energetic component 504 the polymer substrate 510 experiences the same environmental conditions and accordingly ages in a similar manner to the energetic component 504. Environmental conditions and age precipitate changes in the energetic component 504 and the polymer substrate 510. The change in composition of the polymer substrate 510 is, in one example, measured according to detectable changes in electrical properties with the contacts 512. A conductive particulate 508 included with the polymer substrate 510 facilitates the measurement of one or more of resistance, current, voltage or the like across the polymer substrate 510. In a resistive measuring example as the resistance changes and measured the change is compared to a database of values to determine the age and corresponding composition of the energetic component 504.

In one example the age of the polymer substrate 510 (e.g., including its age based on compositional changes corresponding to changes in the energetic component 504) is used to identify a failure event of the energetic component 504. For example, with a particular age (and corresponding compositional change) the energetic component 504 decays to the point that one or more operational characteristics of the energetic component 504 (e.g., one or more of thrust, explosive capability or the like) is no longer achievable with the aged energetic component 504. The failure identification module 324 (FIG. 3B) identifies this age as a failure event indicating that the corresponding effector should be pulled from service and decommissioned.

Each of the characteristic sensors 400, 500 shown in FIGS. 4 and 5 are example sensors configured to measure one or more failure characteristics The failure characteristics measured by each of the characteristic sensors 400, 500 are delivered to the failure identification module 314 to identify corresponding failure events and alert an operator, system or the like to remove the corresponding effector 100 from service. As further described herein, these failure events are, in other examples, used to develop a failure model including one or more of generation of an initial failure model, refinement of a failure model or the like with the effector health monitoring system 314 as described herein.

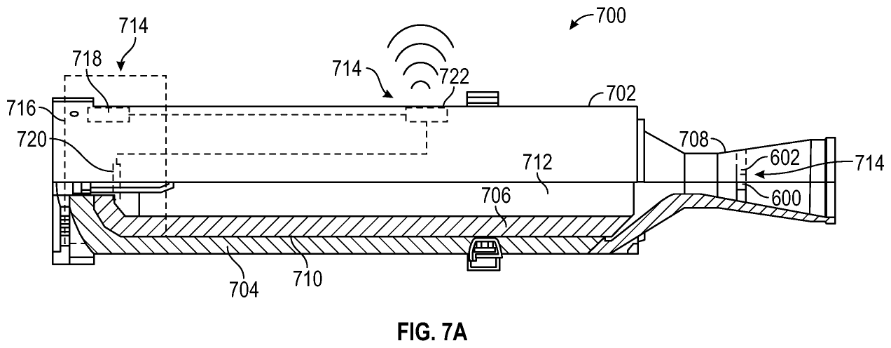

FIG. 6 shows another example of a characteristic sensor 600. In this example, the characteristic sensor 600 is a component of a weather seal 602 provided in the nozzle 308 of an effector, such as the effector 300. The weather seal 602 (e.g., a ‘smart’ weather seal) encloses one or more of the combustion chamber 610, the center bore 312 and other internal components of the effector 300. The weather seal 602 is used, in one example, to protect the sensitive components on the interior of the effector 300. The characteristic sensor 600 mounted in the weather seal 602 measures one or more characteristics proximate to the sensitive components of the effector 300 including, but not limited to, the propellant grain 306. For example, the characteristic sensor 600 includes one or more component sensors including, but not limited to, temperature, humidity, pressure, chemical (e.g., chemical sniffer to measure outgas composition), vibration, mechanical shock sensors or the like. In other examples, the characteristic sensor 600 includes one or more sensors configured to sense failure events (e.g., failure characteristics indicative of a failure event) including, but not limited, polymer aging sensors (thermal aging sensors configured to apply a thermal pressure algorithm), fiber Bragg grating sensors (configured to measure mechanical and chemical changes through light and doppler changes), accelerometers to measure strain and shear (correlates to pressure and stress), pressure sensors (corresponding to stress/strain in the propellant grain) or the like.

The component sensors of the characteristic sensor 600 are in communication with one or more other components of the effector health monitoring system 314 including the communication hub 322. In an example, the characteristic sensor 600 communicates with the communication hub 322 previously sown in FIG. 3A by a wired connection extending from the nozzle 308 to the communication hub 322 along an exterior of the effector 300. In another example, the weather seal 602 includes a wireless transmitter configured to transmit (and optionally receive) data to the communication hub 322. Optionally, the weather seal 602 is the communication hub 322 (or 722 in FIGS. 7A, B). In this example, characteristic sensor measurements are communicated from the corresponding sensors (including sensors on board the weather seal) to the weather seal 602 as the communication hub. The weather seal communicates the measurements (e.g., of environmental characteristics, failure characteristics or the like) to one or more access tools, as described herein.

The effector health monitoring system 314 shown in FIG. 3A optionally includes one or more environmental sensors including, for instance, the first characteristic sensor 318, shown in FIG. 3A positioned proximate to an exterior of the effector body 302 and one or more additional sensors provided in the weather seal 602 at the nozzle 308. Optionally, the first characteristic sensor 318, shown in FIG. 3A, includes one or more component sensors in a similar manner to the characteristic sensor 600 shown in FIG. 6. For instance, the first characteristic sensor 318 includes a plurality of component sensors including one or more of vibration, mechanical shock, temperature, humidity, pressure, sensors or the like. In one example, the component sensors of the first characteristic sensor 318 are redundant or duplicative to component sensors included in the characteristic sensor 600. The inclusion of additional sensors facilitates the measurement and confirmation of one or more environmental characteristics and further enhances the confidence of identified failure events and predicted failure events based on one or more failure models (as described herein).

In another example, the effector health monitor system 314 (or 714 shown in FIGS. 7A, B) communicates through the communication hub 322 (or 722) included as a component of the weather seal 602. For example, the weather seal 602 is a ‘smart’ weather seal and includes a communication hub interfaced with one or more of the characteristic sensors 318, 320, 600 (718, 720, 726 in FIGS. 7A, B), of the effector health monitor system 314 (or 714). Accordingly, measurements, control instructions, diagnostic functions or the like are provided to and from the weather seal 602 with the various characteristic sensors, and optionally one or more access tools including the failure identification modules 324, 728 or the like. The interface between the sensors and the weather seal 602 (e.g., the communication hub) includes one or more of wireless or wired interfaces. In the example of a wired connection connections are optionally delivered from an exterior facing surface of the weather seal to corresponding ports on the effector body associated with the characteristic sensors. In a wireless interface, signals are broadcast to and from the various sensors and the communication, for instance by way of a transmitter, receiver, transceiver or the like, including, but not limited to, Bluetooth, infrared, radio, optical or other wireless formats.

As previously discussed herein, the weather seal includes one or more characteristic sensors 600. In one example, the characteristic sensor 600 includes one or more component sensors configured to measure environmental characteristics proximate to the propellant grain 306. In another example, the one or more component sensors include failure characteristic sensors. For instance, a sample of the propellant is retained along an interior surface of the weather seal 602 as a component of a thermal aging sensor, polymer aging sensor or the like (e.g., an example is shown in FIG. 5). The propellant sample is exposed to similar environmental conditions as the propellant grain 306, and accordingly changes in the propellant sample correspond to changes of the grain. Polymer age (e.g., one example of a failure characteristic) is accordingly measured with the propellant sample provided along the weather seal 602 with the polymer aging sensor (500 in FIG. 5). FIGS. 7A and 7B show another example of an effector health monitor system 714. Referring first to FIG. 7A, a portion of an effector 700 is shown including an effector body 702 having an energetic component, such as a rocket motor 704. The rocket motor 704 includes a propellant grain 706 extending along and coupled with a liner 710. A center bore 712 of the rocket motor 704 extends to and through the nozzle 708.

As further shown in FIG. 7A, the effector health monitor system 714 is provided at one or more locations of the effector body 702 including, but not limited to, within the interior of the effector 700, proximate to the exterior, along the exterior or the like. The characteristic sensors 718, 720 are configured to measure one or more environmental characteristics including, but not limited to, pressure, temperature, humidity, vibration, mechanical shock, chemical characteristics (polymer age, outgassing composition), change in the characteristics, rates of change or the like.

Each of the first and second characteristic sensors 718, 720 are, in one example, components of a characteristic sensor suite 716 that measures the environmental characteristics and communicates measurements to a communication hub 722. The communication hub 722 includes a transmitter, transceiver or the like configured to relay environmental characteristic measurements to other components of the system. Additional components include, but are not limited to, assessment tools such as tablet computers, cellphones, smartphones, remote access devices, network hubs, processors, service modules or the like. The assessment tools include a failure identification module 728, shown in FIG. 7B. The failure identification module 728 receives information from the effector communication hub 722 and analyzes the measured one or more environmental characteristic measurements to identify one or more failure events including predictive determination of failure events, contemporaneous determination of failure events or the like.

In another example, the communication hub 722 includes an onboard processor, memory or the like including the failure identification module 728. The communication hub 722 having the module 728 is configured to interpret and analyze environmental characteristic measurements from the characteristic sensor suite 716 and identify one or more failure events (e.g., contemporaneously, predictively or the like). The communication hub 722, in this example, communicates the identified failure event, for instance with a display, wireless notification, audible alert, visual alert or the like.

In either case, whether onboard or remote relative to the remainder of the effector health monitor system 714 on the effector 100, the effector health monitor system 714 having the failure identification module 728 is configured to apply measured environmental characteristics unique to the associated effector 100 (or 700) to one or more failure models and identify a failure event including one or more of a forthcoming failure event, contemporaneous failure event or the like.

Referring again to FIG. 7A, a weather seal 602 is provided within the nozzle 708. As previously described, the weather seal 602 isolates and protects one or more components of the rocket motor 704 including, but not limited to, the propellant grain 706. In other examples, a weather seal or similar feature is configured to protect or isolate one or more energetic components such as warheads, munitions, squib charges or the like. In the example shown in FIG. 7A, the weather seal 602 includes a characteristic sensor 600. The characteristic sensor 600 is another example of a characteristic sensor that is a component of the characteristic sensor suite 716 including one or more sensors, such as the first and second characteristic sensors 718, 720. As previously described, the characteristic sensor 600 is, in one example, a composite sensor including one or more component sensors configured to measure one or more environmental characteristics in or around the rocket motor 704 including one or more of temperature, humidity, pressure, vibration, mechanical shock, changes in the same, rates of change of the same or the like associated with the effector 700, the rocket motor 704 and its propellant grain 706. In one example, the weather seal 602 is configured to provide environmental measurements both for the exterior of the effector 700, for instance, along an exterior face of the weather seal 602 and along an interior, for instance, along an interior face directed toward the center bore 712 of the rocket motor 704.

The characteristics measured by the characteristic sensor 600 are submitted through the communication hub 722 along with additional characteristic measurements made with the first and second characteristic sensors 718, 720 to the failure identification module 728 shown in FIG. 7B. The composite information provided to the failure identification module 728 is used to identify one or more failure events including forthcoming and contemporaneous failure events.

FIG. 7B is a schematic view of the effector health monitor system 714 previously shown in FIG. 7A. The effector health monitor system 714 includes the characteristic sensor suite 716 including one or more characteristic sensors including, but not limited to, the first characteristic sensor 718, second characteristic sensor 720 and one or more (N) additional characteristic sensors 726. Optionally, one example of the characteristic sensor 726 includes the sensor 600 associated with the weather seal 602.

In the example shown in FIG. 7B, a plurality of characteristic sensors are provided with the characteristic sensor suite 716 and measure one or more environmental characteristics including, but not limited to, pressure, temperature, humidity, chemical characteristics, vibration, mechanical shock, changes of the same, rates of changes of the same or the like. As further shown in FIG. 7B, the characteristic sensor suite 716 is in communication with the communication hub 722, for instance, by one or more of wired or wireless connections. The communication hub 722 is, in turn, in communication with the failure identification module 728.

In the example shown in FIG. 7B and previously shown in FIG. 7A, the characteristic sensor suite 716 includes characteristic sensors 718, 720, 726 configured to measure environmental characteristics. In contrast, the previously described effector health monitor system 314 shown in FIGS. 3A, 3B, includes one or more failure sensors such as the second characteristic sensor 320 configured to measure one or more characteristics indicative of a failure event in the effector 100 such as stress, strain, temperature, thermal resistance, compositional changes, thermal aging or the like of one or more energetic components including, for instance, the propellant grain 306. Additionally, the health monitor system 314 includes at least one environmental characteristic sensor 318 that measures environmental characteristics, such as pressure, humidity, temperature, vibration, mechanical shock or the like. The failure characteristic measurements are provided to the failure identification module 314 to identify a failure event. Each of the failure characteristic measurements and the environmental characteristic measurements are provided to the failure model generation module 330 to generate a failure model including development of an initial failure model, refinement of existing failure models or the like based on both the environmental characteristic measurements associated with the corresponding failure events identified with the failure identification module 324.

Referring again to FIG. 7B, the failure identification module 728 (remote relative to the effector 100 or onboard) identifies one or more failure events (predictively, contemporaneously or the like) based on analysis of the environmental characteristic measurements received from the communication hub 722 and the sensors provided with the effector 100. The failure identification module 728 analyzes the environmental characteristic measurements unique to the effector 100 and applies the measurements to one or more failure models 730 to accordingly identify a failure event, and does so without the failure-based characteristic sensor 320 used with the monitor system 314 shown in FIGS. 3A, B. The effector health monitor system 714 shown FIG. 3B does not include failure characteristic based sensors. Instead, the system 714 includes the one or more environmental characteristic sensors 718, 720, 726.

The failure identification module 728, shown in FIG. 7B, includes one or more failure models 730 that identify failure events based on measurements of environmental characteristics unique to the effector having the effector health monitor system 714. The module 728 has one or more failure models including, but not limited to, functions such as Arrhenius Equations, empirically generated functions, a suite of component failure models or the like. The failure identification module 728 applies the environmental characteristic measurements to the one or more failure models to identify one or more various failure events including, but not limited to, one or more of fracture of the propellant grain 706, bond separation of the propellant grain 706 from the liner 710, solder cracking in one or more associated components of the rocket motor 704, a chemistry change, integrated circuit delamination or the like.

In the example shown in FIG. 7B, the characteristic sensor suite 716 is without one or more of the failure characteristic sensors previously described herein. In this example, the environmental characteristic sensors are used in combination with the failure identification module including one or failure models 730 therein, to analyze environmental characteristic measurements and accordingly identify one or more failure events unique to the effector 100 based on its unique environmental experiences measured with the environmental characteristic sensors 718, 720, 726 or the like. The failure identification module 728 predicts failure events based on the environmental measurements provided by the characteristic sensor suite 716 and applied to the failure models. Accordingly, the one or more failure characteristic sensors 320 included in the effector health monitor system 314 (FIGS. 3A, 3B)are optionally withheld from the effector health monitor system 714 thereby providing a streamlined monitor system that is less expensive and less labor intensive while at the same time configured to identify failure events based on measured environmental characteristics.

The effector health monitor system 714 optionally includes a model refinement interface 732 (shown in dashed lines in FIG. 7B). The model refinement interface 732 provides an interface to the failure identification module 728 to facilitate the updating of one or more of the failure models 730 included in the failure identification module 728. For instance, in a manufacturing lot of effectors having the effector health monitor systems 714 and the effector health monitor systems 314 having failure characteristic sensors one or more failure events are, in various examples, identified throughout the service lifetime of the effectors 100 associated with the lot. These identified failure events and their associated environmental characteristic measurements are, in various examples used(e.g., by the failure identification module 324 and failure model generation module 330 shown in FIG. 3B), to generate models, develop additional models, refine models or the like to enhance identification of failure events. In one example, the additional failure models including refinements of initial models are uploaded to the failure identification module 728 of the monitor system 714 through the model refinement interface 732. In this manner, the effector health monitor system 714 is not a static system and instead is updated on an ongoing basis with further refined failure models 730 to accordingly enhance the accurate identification of failure events associated with each of the effectors 100, including an effector health monitor system 714 that does not include failure characteristic sensors.

As one example, effector health monitor systems 314 and the associated failure characteristic sensors 320 are included in a subset of the effectors 100 of a particular manufacturing lot. The remainder of the effectors 100 of the manufacturing lot are instead equipped with the streamline effector health monitor system 714 one or more environmental characteristic sensors 718, 720 or the like. The effector health monitor systems 314 identify additional failure events and accordingly develop (including refining) failure models unique to the effectors of the manufacturing lot. The failure model 730 associated with the failure identification module 728 of the effector health monitor system 714 is updated with these failure models. Accordingly, the streamline system 714 benefits from the effector health monitor system 314 and the refined failure models generated by the system 314. The failure identification module 728 having the model refinement interface 732 is updated in an ongoing manner to refresh the onboard failure models 730 and enhance the identification of failure events based on measured environmental characteristics.

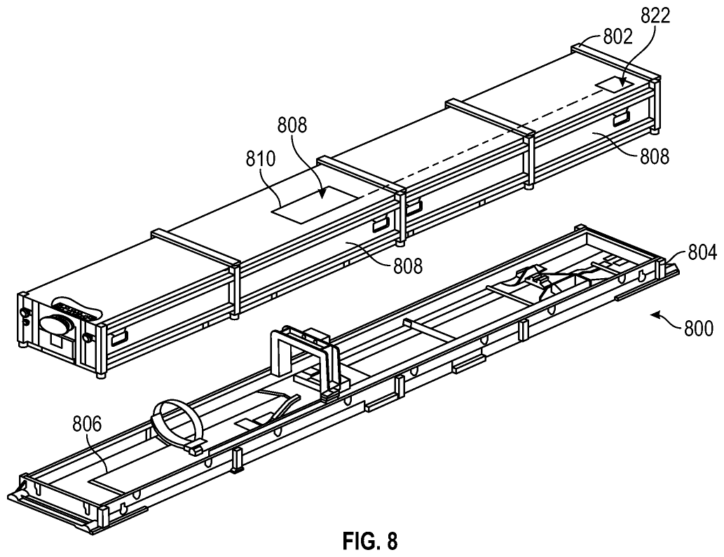

FIG. 8 shows one example of an effector storage housing 800. As shown, the effector storage housing 800 includes a housing base 804 configured for coupling with a housing casing 802. In this example, the housing base 804 and housing casing 802 are exploded and accordingly provide a view of an effector tray 806. The effector tray 806 retains one or more effectors along the housing base 804 while the housing casing 802 is provided over top of the housing base 804 and coupled with the base to securely store the effectors until needed.

In one example, the effector storage housing 800 includes one or more features or components of an effector health monitor system 808. The effector health monitor system 808 is, in various examples, a component of one or more of the effector health monitor systems 314, 714, previously described herein and associated with an effector 100 shown, for instance, in FIG. 7B. The effector 100 is stored along the effector tray 806 (e.g., coupled, buckled, affixed or the like) and the housing casing 802 is coupled over the housing base 804 to securely store the effector 100 therein. The effector health monitor system 808 includes one or more components configured to interface with the various components of the monitor systems 314, 714, for instance, by way of an access module 810 including a communication hub. The communication hub of the access module 810 is configured to wirelessly (or by wired connection) communicate with one or more of the components of the effector health monitor systems 314, 714 including, for instance, the characteristic sensors 318, 320 or 718, 720 or their respective communication hubs. In another example, the access module 810 communicates with one or more characteristic sensors 822 associated with one or more of the housing base 804 or housing casing 802. The one or more characteristic sensors 822 measure environmental characteristics local to the effector (and potentially failure characteristics) within the effector storage housing 800. The characteristic sensors 822 include one or more of the sensor types previously described herein with regard to the sensors onboard an effector for the effector health monitor systems (e.g., environmental or failure characteristic sensors). In one example, the access module 810 communicates with communication hubs 322, 722 of the various effector health monitor systems 314, 714. In another example, the access module 810 of the effector storage housing 800 is configured to provide a wired connection to each of the one or more sensors of the characteristic sensor suites 316, 716 of the various systems 314, 714, for instance with a wiring umbilical coupled between the effector and the module 810 (or corresponding port of the housing).

The access module 810 provided along the effector storage housing 800 optionally includes one or more components of the effector health monitor systems 314, 714 described herein including, but not limited to, one or more of a failure identification module, failure model generation module or both. In one example, with the effector health monitor system 714 (FIG. 7B) the access module 810 includes the failure identification module 728 and the one or more onboard failure models 730. Optionally, the access module 810 includes additional components, such as the model refinement interface 732. In another example, the access module 810 includes components of the effector health monitor system 314, previously shown and described in FIG. 3B. For instance, the access module 810 includes the failure identification module 324 and the failure model generation module 330. In still another example, the failure module 810 provides one or more displays or other output devices configured to facilitate observation or alerting to one or more of the measurements, stored values, identified failure events, access to underlying models or the like stored with the effector health monitor system 808 or one or more of the effector health monitor systems associated with the effectors 100 shown in FIGS. 3B, 7B. In one example, the access module 810 allows an operator, technician or the like to have ready access to one or more measured characteristics, identified failure events, failure models or other information of interest stored, processed or analyzed by the effector health monitor systems described herein. In another example, the access module 810 provides an output device such as a data port, wireless control node, wireless access node or the like configured to allow another access tool such as a tablet computer, laptop computer, hand device, cellular phone, mobile device or the like to access the logged measurements, failure models, identified failure events for the effector health monitor systems. Stated another way, if one or a plurality of effectors 100 are stored in the effector storage housings 800 or consolidated in a larger container, the access module 810, in one example, provides ready access to the unique environmental characteristics measured by each of the effector health monitor systems, identified failure events, failure models associated with each of the effectors. One or more of data manipulation, data analysis, updating or generation of failure models, is readily facilitated by way of access to the relevant data for each of the effectors 100 stored. Time consuming and labor intensive removal of the effectors from storage such as storage cases, shipping containers, ship holds, storage warehouses or the like to access the effectors 100 and conduct one or more of destructive or nondestructive testing is accordingly avoided. Instead, the effector health monitor systems 714, 314 described herein and the optionally access module 810 provide ready access to one or more of the logged environmental or failure characteristic measurements, identified failure events, failure models or the like stored with the effector health monitor systems.

The effector health monitor systems 314, 714 described herein are provided to related effectors, for instance effectors 100 of the same type, manufacturing lot or the like. The effector health monitor systems 314, 714 identifying an effector failure event of an energetic component through the measurement of environmental characteristics experienced by the effector (e.g., proximate to the energetic component) and applying the measurements (at least one of the measurements) to one or more failure models. A failure event is identified based on the application to the failure model. In one example, the failure model includes a series of failure thresholds applied in combination with measured characteristics, such as failure characteristics, measured with the at least one failure characteristic sensor 320 shown in FIG. 3B. The failure characteristic sensor 320 includes, but is not limited to, stress/strain, stress/strain and temperature sensor (e.g., a dual bonded stress/strain and temperature sensor, DBST), polymer aging (e.g., a thermal aging sensor using a thermal pressure algorithm), chemical composition sensor (e.g. a fiber Bragg grating instrument), accelerometers calibrates to measure strain and shear, energetic component pressure or the like. Measurement of characteristics with one or more of these sensors are compared with corresponding failure thresholds at the failure identification module 324 to identify failure events.

In another example, the failure model includes one or predictive failure models. The predictive failure models are based on prior identified failure events (e.g., in effectors of the same type) associated environmental characteristics, and optionally one or more of historical behavior of components, identified failure events identified through destructive or nondestructive testing or the like. As described herein below, these failure models cooperate with the unique measured environmental characteristics for an associated effector having the monitor system to provide predictive identification of one or more failure events. In some examples, an estimate service life (ESL), remaining service life (RUL) is determined to facilitate the continued service of the effector having the predicted failure event until the ESL/RUL is achieved.

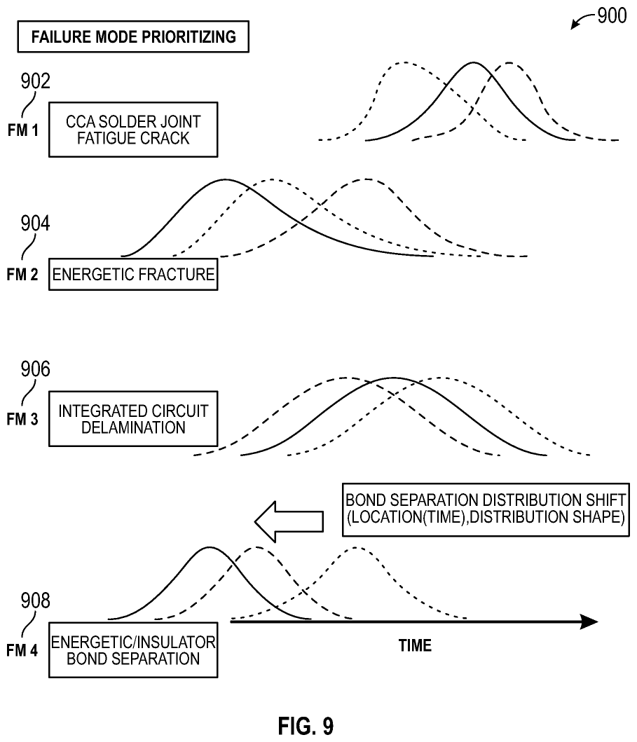

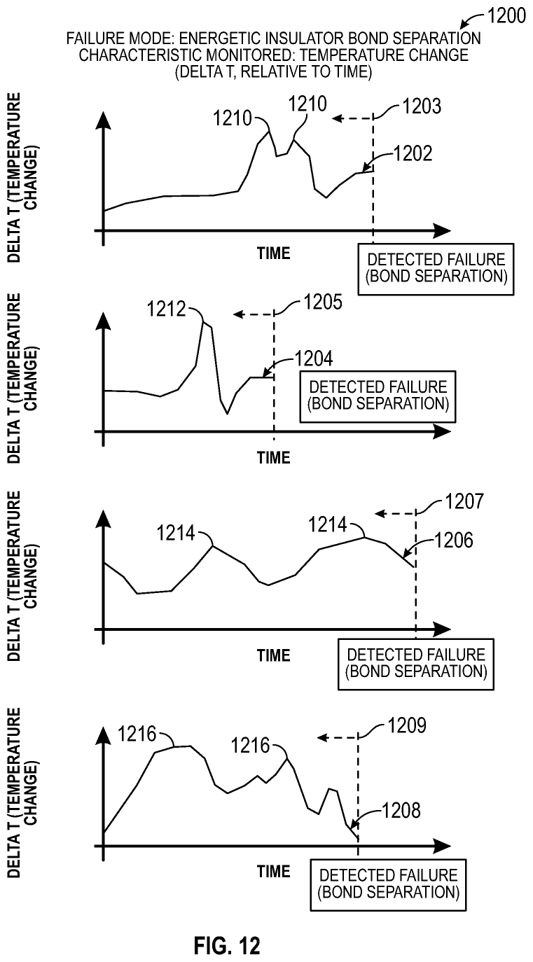

FIGS. 9-14 include plots of measured environmental characteristics, probability distribution functions, and cumulative distribution functions as exemplary illustrations of predictive failure identification based on the application of one or more failure models (FIGS. 9-11) and failure model generation including refinement (FIGS. 12-14). While FIGS. 9-14 provide examples, other measurements, distributions and models are encompassed by the description.

FIG. 9 shows one example of a failure mode sensitivity plot 900. In this example, the plot 900 includes a plurality of failure modes including first, second, third and fourth failure modes 902, 904, 906, 908. As indicated with labels in FIG. 9, the failure mode 902 includes fatigue based fracture or cracking of a solder joint. The failure mode 904 corresponds to an energetic fracture, for instance, a fracture of a propellant grain 306, 706 shown in FIGS. 3A, 7A. Another example failure mode 906 integrated circuit delamination. The fourth example failure mode 908 includes a failure of the energetic component, for instance bond separation between the energetic component (e.g., propellant grain 306, 706) and the liner or insulator such as the liner 310, 710 (of FIGS. 3A, 7A).

The failure modes 902-908, shown in FIG. 9 are exemplary failure modes for effectors a manufacturing lot 200 (see FIG. 2). The list shown in FIG. 9 is not exclusive and instead is exemplary and provided to illustrate sensitivity across the failure modes based on experienced environmental conditions.

As shown in FIG. 9, the failure modes 902-908 each include multiple probability distribution functions plotted relative to time. Each of the probability distribution functions for each of the failure modes 902-908 varies in one or more of location (time) or shape (time span and probability) or the like. Variations in location or shape are based on differing stress inputs, such as different measured environmental characteristics for the constituent effectors. For example, the right most component distributions for each of the failure modes 902-908 is generated from effectors having failure events associated with a first measured environmental characteristic. The middle component distributions are generated from effectors having failure events associated with a second measured environmental characteristic greater than the first. Similarly, the left most component distributions are generated from effector failure events associated with a third measured environmental characteristic greater than the second. Higher stress inputs (e.g., measured environmental characteristics such as greater temperatures, pressures, humidity, vibration, shock, change of the same or rates of change) generally increase wear, accelerate failure events and are reflected by the left most (earlier occurring) distributions for each of the failure modes. Conversely, relatively lower stress inputs reduce wear, delay failure events and are reflected by the right most (later occurring) distributions.

Larger variations (shape and location) between component distributions in some of the failure modes relative to the other failure modes indicate the effector is more sensitive to environmental conditions for that failure mode. For instance, the distributed locations and profiles (shapes) of the distributions of the second and fourth failure modes 904, 908 relative to the more closely associated distributions of the failure modes 902, 906, indicate failure modes 904, 908 are most sensitive to environmental conditions, and accordingly have a higher priority for observation including failure identification as described herein. Optionally, one or more of location and profile of the distributions for the failure modes 902-908 are compared with the locations and profiles of distributions for the other failure modes (e.g., through a difference function, inequality or the like) to prioritize the failure mode having the greatest variability.

The priority of one or more of the failure modes (e.g., 904, 908) as determined, for instance by one of the failure identification modules described herein, provides greater weight to one or more stress inputs associated with the prioritized failure modes. In another example, the effector health monitor systems 314, 714 more closely analyze and monitor one or more stress inputs (measured environmental characteristics) associated with the prioritized second and fourth failure modes 904, 908, in this example. For instance, if energetic fracture or energetic insulator bond separation are the most likely failure events based on analysis of the failure modes (as shown in FIG. 9) each of the stress inputs associated with the failure mode 904 and failure mode 908 are followed and analyzed more closely with one or more of higher sampling rates, higher resolution measurements, additional instruments or the like. For example, temperature measurements or change in temperature (delta temperature) are most closely associated with the prioritized second and fourth failure modes 904, 908 of the effectors 100, 300. Accordingly, one or multiple temperature sensors associated with the effector 100, 300 are monitored with a higher sampling rate, include higher resolution sensors or the like relative to other environmental characteristic sensors (e.g., humidity, pressure or the like in contrast to temperature in the example) that measure characteristics deemed less predictive or are associated with less sensitive failure modes.

In other examples, the more sensitive failure modes, such as the failure modes 904, 908 are most closely related to a plurality of environmental characteristics, for instance, delta temperature, pressure, humidity or the like. In this example, the corresponding sensors are accordingly provided with a higher resolution, sampling rate or the like to accordingly more closely monitor the environmental characteristics most closely associated with those failure modes.

In the example shown in FIG. 9, the second and fourth failure modes 904, 908 indicate failure of an effector such as the effector 100, 300 is most likely to occur relative to those failure modes prior to failure caused by one or more of the first or third failure modes 902, 906. Accordingly, in this example, the failure mode sensitivity plot 900 (or its mathematical equivalent) is used to select the second and fourth failure modes 904, 908 for close monitoring while, in some examples, providing a lesser weight, attenuated monitoring or analysis of other failure modes including the first and third failure modes 902, 906. Optionally, based on the prioritization of the failure mode sensitivity plot 900, one or more of the effector health monitor systems 314, 714 are configured to select one or more of the monitored failure modes for high resolution analysis, monitoring or the like to accordingly identify failure events (including predictively or contemporaneously) at a higher frequency and with greater sensitivity in various examples. For instance, in one example, the effector health monitor systems 314, 714, for instance, with one or more of the failure identification modules 324, 728 prioritizes failure modes in an ongoing manner such as the failure modes 902, 908 based on analysis and comparison of failure modes 902-908 as they are updated, for instance by way of revised failure models.

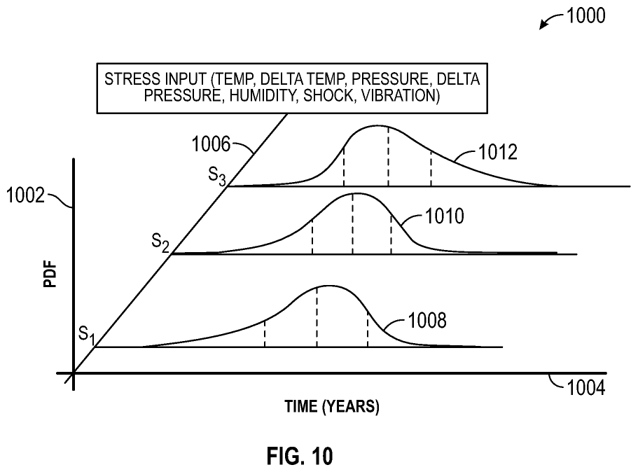

FIG. 10 shows a failure stress plot for the example prioritized failure mode 908 of FIG. 9. For instance, in this example, the plot 1000 includes probability distribution functions (PDF) 1008, 1010, 1012 corresponding to the selected failure mode 908 shown in FIG. 9 and graduated according to input stress (e.g., a measured environmental characteristic, such as temperature or delta temperature). In this example, the PDFs shown in FIG. 9 for the failure mode 908 are instead plotted according to variable stresses along the stress axis 1006 (z-axis into the page). The PDFs 1008, 1010, 1012 are further plotted along a time axis 1004 and a probability axis 1002. As shown, with increasing stress (e.g., measured environmental characteristics Si, S2, S3 and so on) the PDFs 1008, 1010, 1012 gradually change location, profile or both to reflect the increased stress input and corresponding accelerated probability of the failure mode 908 occurring for the effectors 100, 300.

For instance, as shown in FIG. 10, the probability distribution function (PDF) 1008 for stress S₁ has a generally bell-shaped configuration positioned approximately midway along the time axis 1004. In contrast, the higher stress S₂ (e.g., a greater change in temperature, change in temperature over time or the like) and the corresponding probability distribution function 1010 for the stress S₂ also generally maintains the bell shape previously shown for PDF 1008 while moving the PDF 1010 laterally to the left, closer to the origin and accordingly earlier along the time axis 1004. Further, the PDF 1012 based on S3 is further shifted along the time axis 1004 and has a leftward (earlier biased) shaped PDF 1012 that indicates the likelihood of failure increases as the input stress increases. Accordingly, as a general trend in FIG. 10, the failure mode such as the failure mode 908, shown in FIG. 9, and corresponding to a bond separation between the propellant grain 306 and the liner 310 is more likely to occur as the input environmental stress is increased based on the PDFs 1008, 1010, 1012.

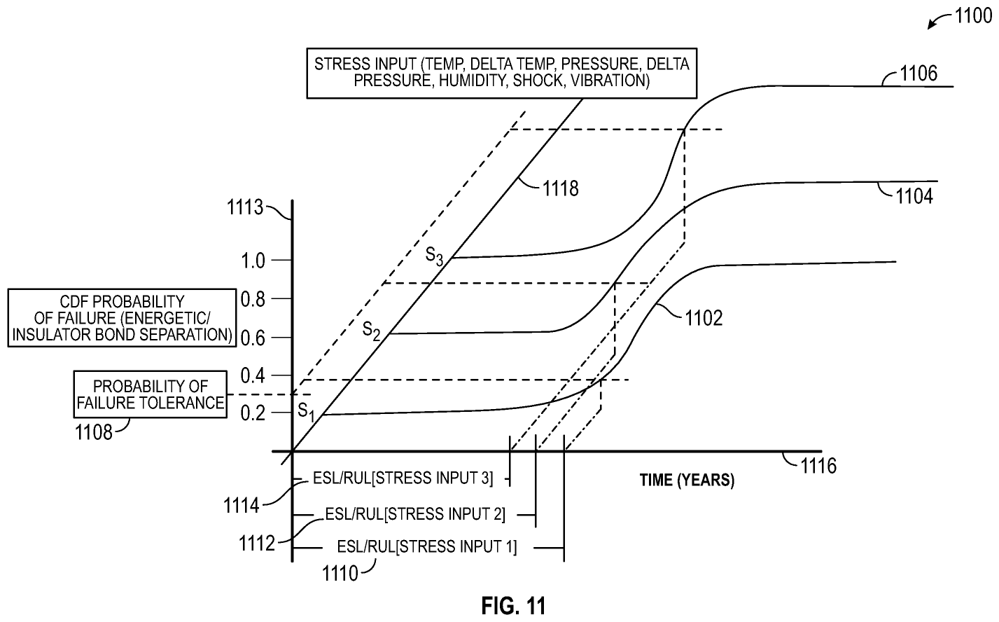

Based on the example probability distribution functions shown in FIG. 10, one or more cumulative distribution functions (CDF) are readily plotted relative to time, probability of failure and the corresponding stress input. FIG. 11 shows the CDFs corresponding to the PDFs of FIG. 10. For instance, the component failure model 1102, shown in FIG. 11, corresponds to the PDF 1008 shown in FIG. 10. Similarly, the component failure model 1104 corresponds to the PDF 1010 and the component failure model 1106 corresponds to the PDF 1012 also shown in FIG. 10. As shown in FIG. 11, the component failure models 1102, 1104, 1106 each have different locations and shapes based on the differences between the PDFs 1008, 1010, 1012 of FIG. 10. The component failure model 1106 indicates an increased probability of bond separation failure than the model 1102.

In one example, the component failure models 1102, 1104, 1106 based on varied stress inputs (e.g., environmental characteristic measurements) are component models of an overall failure model 1100. Stated another way, the failure model 1100, in one example, includes a plurality of component failure models 1102, 1104, 1106 and so on that vary according to one or more stress inputs including, for instance, measured environmental characteristics, for instance, measured with one or more of the effector health monitor systems 314, 714. As described herein the effector health monitor systems 314, 714 optionally selects the appropriate component failure model 1102-1106 corresponding to the instant measured environmental characteristic (e.g., the environmental stress Si, S2, S3 and so on).

The failure model 1100 further includes a specified failure tolerance 1108 (optionally referred to as a specified failure occurrence probability). In one example, the specified failure tolerance 1108 corresponds to a customer specified failure tolerance for the effector 100, 300 or one or more components of the effector. In another example, the specified failure tolerance 1108 corresponds to an overall failure tolerance for the various systems, components or the like of the effector 100, 300. In this example, with a plurality of failure models 1100 corresponding to one or more failure modes such as the failure modes 902, 908 described herein, a specified failure tolerance 1108 is, in one example, consistent across each of the failure models 1100 corresponding to those respective failure modes.

In other examples, where one or more systems of the effectors 100, 300 are considered critical, specified failure tolerances 1108 for those corresponding systems and their associated failure modes are lower (e.g., below the 0.3 failure tolerance shown in the example provided in FIG. 11) indicating effectors having the predicted failure mode are decommissioned sooner relative to a higher tolerance. In contrast, secondary or tertiary systems that are considered noncritical for the overall device are optionally assigned a higher specified failure tolerance, for instance, 0.4, 0.5 or the like. Accordingly, the customer may specify one or more failure tolerances 1108 for failure modes associated with prioritized components of the effector to facilitate extension of the service life for an effector 100, 300 while at the same time providing lower failure tolerances 1108 for failure modes associated with critical components of the effector 100, 300 to ensure the effector is pulled from service immediately or soon after identification of the failure event based on the input measured environmental characteristic.

Referring again to FIG. 11, as previously described, the component failure models 1102, 1104, 1106 are plotted along the stress axis 1118 according to the respective stresses such, as S₁, S₂ and S₃. The stresses correspond to one or more measured environmental characteristics, for instance, measured with one or more of the characteristic sensors 718, 720 or 318, 320 (FIGS. 7B, 3B). The input stresses are graduated along the stress axis 1118 and include one or more of temperature, pressure, humidity, vibration, mechanical shock, polymer age, changes of the same, rates of change of the same or the like.

In one example, the stress axis 1118 corresponds to a single input stress (e.g., one of pressure, temperature, change in temperature, change in pressure or the like), and the component failure model 1102-1106 of the model 1100 is selected has a corresponding location on the stress axis 1118 to the input stress. In another example, the stress axis 1118 is graduated according to a weighted combination of various stresses (e.g., a composite stress value). For instance, various environmental characteristic measurements are additively combined (based on weighted unitless values) to facilitate the selection of corresponding failure models based on a combination of input stresses instead of a single input stress. The instant environmental characteristic measurements, from a plurality of sensors of the effector health monitor systems 314, 714 are combined in a unitless fashion to provide composite stress values along the stress axis 1118. Failure models are associated with the corresponding composite stress values.

As previously described and shown in FIG. 11, each of the component failure models 1102, 1104, 1106 are plotted based on input stress along the stress axis 1118. As shown, the component failure model 1106 indicates an earlier failure for the corresponding input stress while the component failure model 1102 is closer to the stress axis 1118 origin thereby having a lower stress (S₁) and as shown indicates a later failure when the effector 100, in one example, is exposed to a corresponding input stress.

As shown in FIG. 11, estimated service lives (ESL) or remaining useful lives (RUL) are plotted for each of the example component failure models 1102-1106 based on example input stresses and the specified failure tolerance 1108. For example, as shown in FIG. 11, the estimate service life 1110 (a time value, such as 12 months, 1.5 years or the like) for the failure model 1102 having the stress input S₁ and the specified failure tolerance 1108 is a greater ESL relative to the ESLs 1112 or 1114 (10 months, 8 months or the like) based on the corresponding failure models 1104, 1106 and associated second and third elevated stress inputs (S₂, S₃). As shown in FIG. 11, the estimated service life for the effector 100 is clearly less with higher input stresses (measured environmental characteristics).

With the example failure models, such as the component failure models 1102, 1104, 1106 of the failure model 1100, the effector health monitor systems 314, 714 described herein are configured to identify failure events including predicted failure events, contemporaneous failure events (if the ESL for the corresponding model is sufficiently short) or the like. For example, referring again to FIG. 7B, a measured environmental characteristic, such as temperature or change in temperature, is measured with the first characteristic sensor 718 (an environmental characteristic sensor) and conveyed to the failure identification module 728.

The failure identification module 728 includes one or more failure models 730, such as the failure model 1100 having component failure models 1102, 1104, 1106. The measured characteristics (including determined characteristics such as change in temperature or change in pressure) received at the failure identification module 728 and applied as stress inputs to the corresponding model. In one example, the failure identification module 728 selects one of the failure models, such as the component failure models 1102-1106 at a location along the stress axis 1118 corresponding to the input stress (e.g., the one or more measured environmental characteristics). The failure identification module 728 determines the estimated service life (e.g., one of ESLs 1110, 1112, 1114) according to the input stress and the corresponding failure model. For instance, with a stress input corresponding to S₂, the failure identification module 728 selects the component failure model 1104 and, based on the input stress as well as the specified failure tolerance 1108, determines an ESL corresponding to the estimated service life 1112 shown in FIG. 11. An indication is provided by the failure identification module 728 including, but not limited to, a logged ESL before a predicted failure event occurs. The indication is provided in one or more formats including, but not limited to, storage of the ESL and predicted failure event for future access or , a broadcast alert, for instance, to an access tool. For instance, referring to FIG. 11, if the input stress occurs at time zero (0), the corresponding estimated service life 1112 extends from the origin to a specified number of years, months or the like indicated along the time axis 1116 based on the failure model 1104 and the specified failure tolerance 1108.

The operator, technician maintaining the corresponding component such as the effector 100 is notified (e.g., receives, downloads, observes a status report or the like) that a forthcoming failure event is likely to occur at the expiration of the estimated service life 1112. If desired, the effector 100remains in service throughout the estimated service life 1112 and is then designated for decommissioning at the expiration of the estimated service life 1112.

In another example, the effector 100 prior to, at the time of, or after expiration of the estimated service life 1112 is examined destructively or nondestructively to determine if an actual failure event has occurred. Optionally, the destructive or nondestructive evaluation and confirmation of a failure event is applied to the one or more failure models (e.g., as an addition to the PDFs and corresponding CDFs, plotted failure event or the like). One or more of the models 1102-1106 of the failure model 1100 is updated to reflect the actual detected event. Additionally, if the predicted failure event has not actually occurred based on examination of the effector (e.g., a false positive) the failure model 1100 is updated, for instance by shifting the PDF and CDF outwardly along the time axes 1004, 1116. Optionally, the updated failure models are distributed throughout the effector health monitor systems 314, 714 for each effector 100 of a manufacturing lot through the model refinement interface 732 (see FIG. 7B) to update and refine ongoing health monitoring for the effectors of the lot. In the example system including the measurement of a plurality environmental characteristics with the systems 314, 714 the measured values are combined as unitless (weighted) values to produce a composite stress value (as discussed herein above). The failure identification modules 324, 728 select a failure model (e.g., 1102-1106 as examples) along the stress axis 1118 corresponding to the composite stress value. With the probability of failure tolerance 1108 and the selected failure model 1102-1106 an estimated service life is determined. The estimated service life indicates that the effector 100 with the measured characteristics, the composite stress value, is predicted to have the corresponding failure event (e.g., bond separation, propellant grain fracture or the like depending on the model) by the expiration of the ESL.

As previously described and shown, for instance, in FIG. 3B, at least one example of the effector health monitor system 314 includes a failure model generation module 330. In one example, the failure model generation module 330 is configured to generate one or more failure models based on previously identified failure events, associated characteristic measurements (failure and environmental characteristics). In another example, the failure model generation module 330 is configured to revise one or more previously existing models, for instance, initial models generated from one or more identified failure events and accordingly update these failure models to improve identification of failure events.

Examples of ongoing environmental characteristic measurements and identified failure events are shown in FIG. 12 as a plurality of collective failure plots 1200. As described herein the failure plots 1200 are generated based on identified failure events 1203, 1205, 1207, 1209 and associated environmental characteristic measurements, for instance change in temperature. The failure events are identified based, in one example, on measurements of one or more failure characteristic sensors (stress/strain, polymer aging or the like) of the effector health monitor system 314, and analysis of the measurements with the failure identification module. In the example shown in FIG. 12, the identified failure events match failure events for the failure model (e.g., model 1100) shown in FIG. 11, bond separation between the propellant grain 306 and the liner 310, for instance, shown in FIG. 3A.

As shown in FIG. 12, each of the identified failure events 1203-1209 are plotted at a location corresponding to the time of occurrence along the time axis. One or more preceding characteristic measurements associated with the failure events are plotted to the left of each of the identified failure events. For instance, in the first view provided in FIG. 12, the identified failure event 1203 is shown on the right portion of the plot while the failure plot 1202 further includes a plot of a delta T (ΔT) or temperature change measured with one or more characteristic sensors, for instance, the characteristic sensor 318 shown in FIG. 3A. As shown in the failure plot 1202, temperature change peaks 1210 precede and are in relative proximity to the identified failure event 1203. The association module 332, shown in FIG. 3B, associates the environmental characteristics measured with the one or more environmental characteristic sensors 318 with the identified failure event.

As further shown in FIG. 12, additional failure plots 1204, 1206, 1208 are provided each with its own respective identified failure event 1205, 1207, 1209. In one example, the identified failure events 1203-1209 correspond to identified failure events with other effectors 100 of a manufacturing lot including the effector health monitor system 314. The association module 332 (FIG. 3B) associates the measured environmental characteristics with the associated failure event and provides a plot, mathematical relationship or the like corresponding to the plots 1202, 1204, 1206, 1208 shown in FIG. 12. In each of these examples, temperature change peaks 1210, 1212, 1214, 1216 are shown relative to the respective identified failure events. As described herein, the temperature change peaks are, in various examples, used in combination with the identified failure events to accordingly generate failure models or updated existing failure models to accordingly enhance the identification (including one or more of the contemporaneous or predictive) of failure events of other effectors of the same type, manufacturing lot or the like as the failed effectors with the identified failure events shown in FIG. 12.

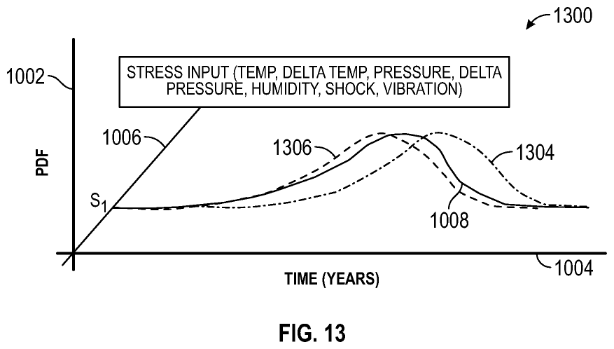

FIG. 13 is a revised stress plot 1300 showing one example of a plurality of probability distribution functions 1008, 1304, 1306 based on a stress input (S₁, corresponding to a measured environmental characteristic). The probability distribution function 1008 in this example corresponds to an initial PDF (previously shown in FIG. 10), and the PDFs 1304, 1306 are example updated PDFs. As described herein, PDFs for a failure mode at a corresponding stress input are in one example used to generate corresponding failure models. As shown in FIG. 11, component failure models 1102-1106 are in one example cumulative distribution functions based on PDFs shown in FIG. 10. Accordingly, an updated PDF (1304, 1306), for instance based on the identified failure events and stress inputs shown in FIG. 12, is used to update the corresponding failure model.

For instance, the revised failure stress plot 1300, shown in FIG. 13, includes these PDFs illustrating changes in the PDF for the same stress value, ΔT (change in temperature, S₁) updated according to additional identified failure events. With the inclusion of additional identified failure events, for instance, identified with the failure identification module 324 (FIG. 3B) or one or more of destructive or nondestructive testing of effectors pulled from service, the initial PDF 1008 is modified to one of the revised PDF 1304 or the revised PDF 1306.

Referring first to the revised PDF 1304, as shown the PDF 1304 has a differing shape and overall location along the time axis 1004 relative to the initial PDF 1008. For instance, in this example, where one or more ΔTs or changes in temperature are measured and corresponding failure events are more attenuated (e.g., occur at a later time relative to the ΔTs than previously predicted) the revised PDF 1304 is moved further out along the time axis 1004 relative to the initial PDF 1008. The additional failure plots 1206, 1208 each include identified ΔT peaks 1214, 1216 earlier in the associated measurements of the ΔT for the effector. In one example, identified failure events 1207, 1209 and the associated preceding environmental characteristic measurements modify the initial PDF 1008 to the revised PDF 1304.

Conversely, the revised PDF 1306 has a modified shape and location relative to the initial PDF 1008 that places the revised PDF 1306 earlier along the time axis 1004. In this example, one or more identified failure events include corresponding temperature change peaks, for instance, the peaks 1210, 1212 and the associated failure events 1203, 1205 of the supplemental failure plots 1202, 1204 indicate a close relationship between ΔT and the failure event (e.g., bond separation). Accordingly, the revised PDF 1306 has a leftward trending location (and profile in this example) relative to the initial PDF 1008 and indicates a higher likelihood of an earlier predicted failure based on the stress input (S₁) input stress.

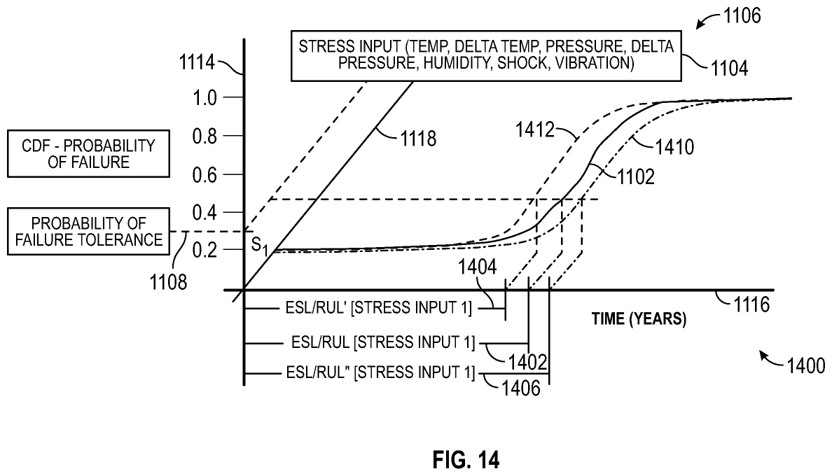

FIG. 14 shows a revised failure model 1400 including, updated failure models 1410, 1412 and an initial failure model 1102 (previously shown in FIG. 11). In this example, the initial failure model 1102 corresponds to the component failure model 1102 (of model 1100). The initial failure model 1102 and updated failure models 1410, 1412 are each plotted along the time axis 1116, the cumulative probability axis 1113 and the stress axis 1118. In this example, each of the initial and revised failure models 1102, 1410, 1412 correspond to a common stress input, for instance, a AT (change in temperature S₁) as shown in FIG. 14.

The initial failure model 1102 includes an estimated service life (ESL) or remaining useful life (RUL) 1402 corresponding to a predicted service life relative to the time of the input stress event (e.g., the origin for the time axis 1116). .

As further shown in FIG. 14, the first updated failure model 1410 is positioned further along the time axis 1116 relative to the initial failure model 1102. As previously described and shown in FIG. 13, the corresponding revised PDF 1304, in one example, indicates an attenuated relationship between ΔT and one or more identified failure events thereby moving the PDF 1304 in a rightward fashion along the time axis 1004. Accordingly, the corresponding revised failure model 1410, provided in FIG. 14, includes an estimated service life 1406 further out along the time axis 1116 and longer than the ESL 1402. Accordingly, based on an input stress corresponding to S₁, the revised estimated service life 1406, shown in FIG. 14, is extended relative to the previously identified initial estimated service life 1402 based on S₁ using the initial failure model 1102. Accordingly, in this example, an effector, such as the effector 100, experiencing the environmental stress input (Δ temperature) corresponding to S₁ remains in service some period of time longer based on the difference between the revised estimated service life 1406 and the initial estimated service life 1402.

In contrast, the revised failure model 1412, shown in FIG. 14, indicates a closer correspondence between the input stress, in this example, Δ temperature, relative to a predicted failure event, in this example a bond separation of the propellant grain from the propellant liner. For instance, and as previously shown in FIG. 13, the revised PDF 1306 includes one or more additional identified failure events occurring in relative proximity to a measured environmental stress as shown in failure plots 1202, 1204 in contrast to the plots 1206, 1208 in FIG. 12. Accordingly, the revised PDF 1306 in FIG. 13 is shifted to the left closer to the origin of the time axis 1004 and the revised failure model 1412 (FIG. 14) based on the revised PDF is thereby also positioned closer to the origin along the time axis 1116. The revised estimated service life 1404 determined from the revised failure model 1412 is less than the estimated service lives 1402, 1406. Accordingly, with the same specified failure tolerance 1108, the estimated service life for an effector such as the effector 100 including an updated model such as the revised failure model 1412 is less than the initial estimated service life 1402.

With this mechanism including, for instance, the generation of models based on development of one or more PDFs and revising or updating of the PDFs, for instance, in the examples shown in FIGS. 12, 13 and 14, accurate and predictive failure models are, in various examples, generated with the failure model generation module 330, shown in FIG. 3B, as a component of the effector health monitor system 314. By revising and updating the failure models in an ongoing manner additional resolution and accuracy for service life predictions for each effector 100 of a specified type or manufacturing lot (including identical or near identical propellant grains, control systems, electronic components, liners or the like) is achieved. Further, by updating the failure models more accurate service life predictions are made and accordingly effectors are maintained in service or removed from service in a predictable manner that is upgraded or updated in an ongoing fashion.

Further, in other examples, for instance, with the effector health monitor system 714, shown in FIG. 7B failure identification modules 728 are provided without failure model generation capabilities. In one example, the failure model such as the failure model 730, shown in FIG. 7B, is updated in an ongoing fashion, for instance, by way of a model refinement interface 732 to accordingly incorporate additional models, revisions, updates or the like to the onboard failure model 730 to enhance the identification of failure events on the effector 100The failure identification module 728 applies one or more failure models including, for instance, updated failure models received through the model refinement interface 732 to accurately predict an estimated service life based on input environmental measurements received from the characteristic sensor suite 716 associated with the effector 100 including the one or more characteristic sensors 718, 720, 726.

In another example, identified failure events and associated stress inputs based on measured environmental characteristics are collected to develop an initial model in a similar manner to the updating described herein. For instance, identified failure events for a particular failure mode (bond separation, propellant grain fracture, solder cracking or the like) are plotted or indexed relative to corresponding stress inputs to populate PDFs similar to the PDFs of FIG. 10. The PDFs are analyzed to generate a corresponding failure model including component failure models (in this example cumulative distribution functions) like those shown in FIG. 11. In an example, the PDFs and associated failure model are updated in an ongoing basis as described herein according to ongoing identification of failure events (e.g., with the effector health monitor systems 314, 714) and examination of decommissioned effectors to identify failure events. Accordingly, as effectors of the same type (e.g., manufacturing lot) age and experience failure events the failure models developed and applied with the effector health monitor systems 314, 714 are enhanced to further refine the identification of failure events, and accordingly provide higher accuracy estimated service lives (ESL) and remaining useful life (RUL). Alternatively, supplemental failure models, for instance for discovered failure types, are readily generated and deployed to the systems 314, 714 described herein including one or more of failure identification modules 324, 728, failure model generation modules 330 or model refinement interfaces 732.

### Various Notes and Aspects

Aspect 1 can include subject matter such as an effector comprising: an effector body including a rocket motor having a solid propellant grain; an effector health monitor system associated with the rocket motor, the effector health monitor system includes: a characteristic sensor suite including at least first and second characteristic sensors coupled with the effector: at least the first characteristic sensor is engaged with the solid propellant grain and configured to measure a failure characteristic of the solid propellant grain; and the second characteristic sensor is configured to measure at least one environmental characteristic proximate to the solid propellant grain; a communication hub coupled with at least the first and second characteristic sensors, the communication hub is configured to communicate the measured failure and environmental characteristics outside of the effector body; a failure identification module configured to compare at least the measured failure characteristic with a failure threshold and identify a failure event based on the comparison; and a failure model generation module configured to log the at least one measured environmental characteristic preceding the identified failure event with the identified failure event.

Aspect 2 can include, or can optionally be combined with the subject matter of Aspect 1, to optionally include wherein the first characteristic sensor includes at least a stress/strain and temperature sensor and a thermal age sensor, and the respective failure characteristic includes one or more of stress, strain and temperature, and temperature and thermal resistance, respectively.

Aspect 3 can include, or can optionally be combined with the subject matter of one or any combination of Aspects 1 or 2 to optionally include wherein the first characteristic sensor includes one or more of power, voltage, current, charge, stress, strain, pressure, conductivity, or chemical sensors.

Aspect 4 can include, or can optionally be combined with the subject matter of one or any combination of Aspects 1-3 to optionally include wherein the second characteristic sensor includes one or more of vibration, mechanical shock, temperature, humidity, pressure, or chemical sensors.

Aspect 5 can include, or can optionally be combined with the subject matter of one or any combination of Aspects 1-4 to optionally include wherein the communication hub includes a wireless transmitter configured to communicate outside the effector body.

Aspect 6 can include, or can optionally be combined with the subject matter of Aspects 1-5 to optionally include wherein the first and second characteristic sensors are configured to measure the respective failure characteristic and environmental characteristic in an ongoing manner.

Aspect 7 can include, or can optionally be combined with the subject matter of Aspects 1-6 to optionally include wherein the rocket motor includes a propellant liner, and the propellant liner houses the solid propellant and at least one of the first or second characteristic sensors therein.

Aspect 8 can include, or can optionally be combined with the subject matter of Aspects 1-7 to optionally include wherein at least one of the first or second characteristic sensors is coupled along an interior surface of the propellant liner and engaged with the solid propellant.

Aspect 9 can include, or can optionally be combined with the subject matter of Aspects 1-8 to optionally include wherein at least one of the first or second characteristic sensors is embedded within the solid propellant.

Aspect 10 can include, or can optionally be combined with the subject matter of Aspects 1-9 to optionally include wherein the effector health monitor system includes an assessment tool, and the assessment tool includes: the failure identification module; the failure model generation module; and a communication interface configured to communicate with the communication hub.

Aspect 11 can include, or can optionally be combined with the subject matter of Aspects 1-10 to optionally include wherein the assessment tool includes one or more of a hand portable reader, smart device, smart phone, laptop, personal computer, effector storage housing, server or server node.

Aspect 12 can include, or can optionally be combined with the subject matter of Aspects 1-11 to optionally include wherein the characteristic sensor suite includes a plurality of sensors, including the second characteristic sensor, configured to measure a plurality of environmental characteristics, and the failure model generation module includes: an association module configured to associate measurements of the plurality of environmental characteristics preceding the identified failure event with the failure event; and a relationship module configured to empirically generate a failure model based on the identified failure event and the associated measurements of the plurality of environmental characteristics preceding the identified failure event.

Aspect 13 can include, or can optionally be combined with the subject matter of Aspects 1-12 to optionally include wherein the failure identification module is configured to compare ongoing measurements of the plurality of environmental characteristics with the failure model to identify another failure event, wherein identification of another failure event includes prediction of another failure event.

Aspect 14 can include, or can optionally be combined with the subject matter of Aspects 1-13 to optionally include wherein the relationship module is configured to empirically generate a plurality of failure models, each of the failure models based on the failure condition for the measured plurality of environmental characteristics associated with the respective identified failure event.

Aspect 15 can include, or can optionally be combined with the subject matter of Aspects 1-14 to optionally include wherein the relationship module is configured to empirically generate a synthesized failure model based on the measured plurality of environmental characteristics associated with a plurality of identified failure events.

Aspect 16 can include, or can optionally be combined with the subject matter of Aspects 1-15 to optionally include an effector comprising: an effector body including a rocket motor having a solid propellant grain; an effector health monitor system associated with the rocket motor, the effector health monitor system includes: a characteristic sensor suite including one or more characteristic sensors coupled with the effector, the one or more characteristic sensors include: a first characteristic sensor configured to measure a first environmental characteristic proximate to the rocket motor; a communication hub coupled with the one or more characteristic sensors, the communication hub is configured to communicate the measured first environmental characteristic outside of the effector body; a failure identification module configured to apply at least the measured first environmental characteristic to a failure model to identify a failure event of the solid propellant grain.

Aspect 17 can include, or can optionally be combined with the subject matter of Aspects 1-16 to optionally include wherein the one or more characteristic sensors include a second characteristic sensor configured to measure a second environmental characteristic proximate to the rocket motor, the second environmental characteristic different than the first environmental characteristic.

Aspect 18 can include, or can optionally be combined with the subject matter of Aspects 1-17 to optionally include a weather seal configured for isolating the solid propellant grain from an exterior environment, and the weather seal includes the second characteristic sensor.

Aspect 19 can include, or can optionally be combined with the subject matter of Aspects 1-18 to optionally include wherein the first characteristic sensor includes one or more of vibration, mechanical shock, temperature, humidity or pressure sensors.

Aspect 20 can include, or can optionally be combined with the subject matter of Aspects 1-19 to optionally include wherein the failure model includes a plurality of failure models, each failure model includes: a first environmental threshold associated with a prior logged failure event; and the failure identification module includes a comparator configured to compare the measured first measured environmental characteristic to the first environmental threshold of the plurality of failure models to identify failure of the solid propellant grain.

Aspect 21 can include, or can optionally be combined with the subject matter of Aspects 1-20 to optionally include wherein the failure model includes a failure model synthesized from previously measured first and second measured environmental characteristics associated with one or more prior failure events.

Aspect 22 can include, or can optionally be combined with the subject matter of Aspects 1-21 to optionally include wherein the failure model includes an empirically synthesized failure model.

Aspect 23 can include, or can optionally be combined with the subject matter of Aspects 1-22 to optionally include wherein the communication hub includes a wireless transmitter configured to communicate outside the effector body.

Aspect 24 can include, or can optionally be combined with the subject matter of Aspects 1-23 to optionally include wherein the rocket motor includes a propellant liner, and the propellant liner houses the solid propellant and at least the first characteristic sensor thereon.

Aspect 25 can include, or can optionally be combined with the subject matter of Aspects 1-24 to optionally include wherein the effector health monitor system includes an assessment tool, and the assessment tool includes: the failure identification module; and a communication interface configured to communicate with the communication hub.

Aspect 26 can include, or can optionally be combined with the subject matter of Aspects 1-25 to optionally include wherein the assessment tool includes one or more of a hand portable reader, smart device, smart phone, laptop, personal computer, effector storage housing, server or server node.

Aspect 27 can include, or can optionally be combined with the subject matter of Aspects 1-26 to optionally include a method for identifying an effector failure event comprising: measuring one or more environmental characteristics including at least a first environmental characteristic, measuring includes: measuring a first environmental characteristic proximate to the energetic component; identifying a failure event based on at least the measured first environmental characteristic, identifying includes: applying the measured first environmental characteristic to at least one failure model; and determining a failure event is forthcoming for the effector based on the application of the measured first environmental characteristic to the at least one failure model.

Aspect 28 can include, or can optionally be combined with the subject matter of Aspects 1-27 to optionally include wherein measuring one or more environmental characteristics includes measuring a second environmental characteristic proximate to the energetic component, the second environmental characteristic different than the first environmental characteristic.

Aspect 29 can include, or can optionally be combined with the subject matter of Aspects 1-28 to optionally include wherein the at least one failure model includes a plurality of failure models, each of the failure models includes at least a first environmental threshold corresponding to a respective prior logged failure event of another effector; and determining the failure event is forthcoming includes comparing the measured first environmental characteristic with the respective first environmental threshold of each of the failure models of the plurality of failure models.

Aspect 30 can include, or can optionally be combined with the subject matter of Aspects 1-29 to optionally include wherein the at least one failure model includes a failure model synthesized from a plurality of previously measured first environmental characteristics associated with respective prior failure events of other effectors; and determining the failure event is forthcoming includes determining the failure event is forthcoming based on the application of the measured first environmental characteristic to the synthesized failure model.

Aspect 31 can include, or can optionally be combined with the subject matter of Aspects 1-30 to optionally include wirelessly communicating the measured first and second environmental characteristics outside of the effector through a communication hub; and receiving the measured first and second environmental characteristics at an assessment tool configured to identify the failure event.

Aspect 32 can include, or can optionally be combined with the subject matter of Aspects 1-31 to optionally include wherein measuring one or more environmental characteristics includes measuring a value, change in the value or rate of change of the value.

Aspect 33 can include, or can optionally be combined with the subject matter of Aspects 1-32 to optionally include Wherein identifying the failure event includes predicting a future failure event.

Each of these non-limiting examples can stand on its own, or can be combined in various permutations or combinations with one or more of the other examples.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An effector comprising:
an effector body including a rocket motor having a solid propellant grain;
an effector health monitor system associated with the rocket motor, the effector health monitor system includes:
a characteristic sensor suite including at least first and second characteristic sensors coupled with the effector:
at least the first characteristic sensor is engaged with the solid propellant grain and configured to measure a failure characteristic of the solid propellant grain; and
the second characteristic sensor is configured to measure at least one environmental characteristic proximate to the solid propellant grain;
a communication hub coupled with at least the first and second characteristic sensors, the communication hub is configured to communicate the measured failure and environmental characteristics outside of the effector body;
a failure identification module configured to compare at least the measured failure characteristic with a failure threshold and identify a failure event based on the comparison; and
a failure model generation module configured to log the at least one measured environmental characteristic preceding the identified failure event with the identified failure event.

2. The effector of claim 1, wherein the first characteristic sensor includes at least a stress/strain and temperature sensor and a thermal age sensor, and the respective failure characteristic includes one or more of stress, strain and temperature, and temperature and thermal resistance, respectively.

3. The effector of claim 1, wherein the first characteristic sensor includes one or more of power, voltage, current, charge, stress, strain, pressure, conductivity, or chemical sensors.

4. The effector of claim 1, wherein the second characteristic sensor includes one or more of vibration, mechanical shock, temperature, humidity, pressure, or chemical sensors.

5. The effector of claim 1, wherein the communication hub includes a wireless transmitter configured to communicate outside the effector body.

6. The effector of claim 1, wherein the first and second characteristic sensors are configured to measure the respective failure characteristic and environmental characteristic in an ongoing manner.

7. The effector of claim 1, wherein the rocket motor includes a propellant liner, and the propellant liner houses the solid propellant and at least one of the first or second characteristic sensors therein.

8. The effector of claim 7, wherein at least one of the first or second characteristic sensors is coupled along an interior surface of the propellant liner and engaged with the solid propellant.

9. The effector of claim 1, wherein at least one of the first or second characteristic sensors is embedded within the solid propellant.

10. The effector of claim 1, wherein the effector health monitor system includes an assessment tool, and the assessment tool includes:
the failure identification module;
the failure model generation module; and
a communication interface configured to communicate with the communication hub.

11. The effector of claim 10, wherein the assessment tool includes one or more of a hand portable reader, smart device, smart phone, laptop, personal computer, effector storage housing, server or server node.

12. The effector of claim 1, wherein the characteristic sensor suite includes a plurality of sensors, including the second characteristic sensor, configured to measure a plurality of environmental characteristics, and the failure model generation module includes:
an association module configured to associate measurements of the plurality of environmental characteristics preceding the identified failure event with the failure event; and
a relationship module configured to empirically generate a failure model based on the identified failure event and the associated measurements of the plurality of environmental characteristics preceding the identified failure event.

13. The effector of claim 12, wherein the failure identification module is configured to compare ongoing measurements of the plurality of environmental characteristics with the failure model to identify another failure event, wherein identification of another failure event includes prediction of another failure event.

14. The effector of claim 12, wherein the relationship module is configured to empirically generate a plurality of failure models, each of the failure models based on the failure condition for the measured plurality of environmental characteristics associated with the respective identified failure event.

15. The effector of claim 12, wherein the relationship module is configured to empirically generate a synthesized failure model based on the measured plurality of environmental characteristics associated with a plurality of identified failure events.

16. An effector comprising:
an effector body including a rocket motor having a solid propellant grain;
an effector health monitor system associated with the rocket motor, the effector health monitor system includes:
a characteristic sensor suite including one or more characteristic sensors coupled with the effector, the one or more characteristic sensors include:
a first characteristic sensor configured to measure a first environmental characteristic proximate to the rocket motor;
a communication hub coupled with the one or more characteristic sensors, the communication hub is configured to communicate the measured first environmental characteristic outside of the effector body;
a failure identification module configured to apply at least the measured first environmental characteristic to a failure model to identify a failure event of the solid propellant grain.

17. The effector of claim 16, wherein the one or more characteristic sensors include a second characteristic sensor configured to measure a second environmental characteristic proximate to the rocket motor, the second environmental characteristic different than the first environmental characteristic.

18. The effector of claim 17 comprising a weather seal configured for isolating the solid propellant grain from an exterior environment, and the weather seal includes the second characteristic sensor.

19. The effector of claim 16, wherein the first characteristic sensor includes one or more of vibration, mechanical shock, temperature, humidity or pressure sensors.

20. The effector of claim 16, wherein the failure model includes a plurality of failure models, each failure model includes:
a first environmental threshold associated with a prior logged failure event; and
the failure identification module includes a comparator configured to compare the measured first measured environmental characteristic to the first environmental threshold of the plurality of failure models to identify failure of the solid propellant grain.

21. The effector of claim 16, wherein the failure model includes a failure model synthesized from previously measured first and second measured environmental characteristics associated with one or more prior failure events.

22. The effector of claim 21, wherein the failure model includes an empirically synthesized failure model.

23. The effector of claim 16, wherein the communication hub includes a wireless transmitter configured to communicate outside the effector body.

24. The effector of claim 16, wherein the rocket motor includes a propellant liner, and the propellant liner houses the solid propellant and at least the first characteristic sensor thereon.

25. The effector of claim 16, wherein the effector health monitor system includes an assessment tool, and the assessment tool includes:
the failure identification module; and
a communication interface configured to communicate with the communication hub.

26. The effector of claim 25, wherein the assessment tool includes one or more of a hand portable reader, smart device, smart phone, laptop, personal computer, effector storage housing, server or server node.

27. A method for identifying an effector failure event comprising:
measuring one or more environmental characteristics including at least a first environmental characteristic, measuring includes:
measuring a first environmental characteristic proximate to the energetic component;
identifying a failure event based on at least the measured first environmental characteristic, identifying includes:
applying the measured first environmental characteristic to at least one failure model; and
determining a failure event is forthcoming for the effector based on the application of the measured first environmental characteristic to the at least one failure model.

28. The method of claim 27, wherein measuring one or more environmental characteristics includes measuring a second environmental characteristic proximate to the energetic component, the second environmental characteristic different than the first environmental characteristic.

29. The method of claim 27, wherein the at least one failure model includes a plurality of failure models, each of the failure models includes at least a first environmental threshold corresponding to a respective prior logged failure event of another effector; and
determining the failure event is forthcoming includes comparing the measured first environmental characteristic with the respective first environmental threshold of each of the failure models of the plurality of failure models.

30. The method of claim 27, wherein the at least one failure model includes a failure model synthesized from a plurality of previously measured first environmental characteristics associated with respective prior failure events of other effectors; and
determining the failure event is forthcoming includes determining the failure event is forthcoming based on the application of the measured first environmental characteristic to the synthesized failure model.

31. The method of claim 27 comprising:
wirelessly communicating the measured first and second environmental characteristics outside of the effector through a communication hub; and
receiving the measured first and second environmental characteristics at an assessment tool configured to identify the failure event.

32. The method of claim 27, wherein measuring one or more environmental characteristics includes measuring a value, change in the value or rate of change of the value.

33. The method of claim 27, wherein identifying the failure event includes predicting a future failure event.
